(19) United States
(12) Patent Application Publication
(10) Pub. No.: US 2023/0245365 A1
(43) Pub. Date: Aug. 3, 2023

(54) VOLUMETRIC AVATARS FROM A PHONE SCAN

(71) Applicant: Meta Platforms Technologies, LLC, Menlo Park, CA (US)

(72) Inventors: Chen Cao, Pittsburgh, PA (US); Stuart Anderson, Pittsburgh, PA (US); Tomas Simon Kreuz, Pittsburgh, PA (US); Jin Kyu Kim, Pittsburgh, PA (US); Gabriel Bailowitz Schwartz, Seattle, WA (US); Michael Zollhoefer, Pittsburgh, PA (US); Shunsuke Saito, Pittsburgh, PA (US); Stephen Anthony Lombardi, Pittsburgh, PA (US); Shih-En Wei, Pittsburgh, PA (US); Danielle Belko, Zurich (CH); Shoou-I Yu, Pittsburgh, PA (US); Yaser Sheikh, Pittsburgh, PA (US); Jason Saragih, Pittsburgh, PA (US)

(21) Appl. No.: 18/074,346

(22) Filed: Dec. 2, 2022

Related U.S. Application Data
(60) Provisional application No. 63/305,614, filed on Feb. 1, 2022.
(60) Provisional application No. 63/369,916, filed on Jul. 29, 2022.

(51) Int. Cl. G06T 13/40

(52) U.S. Cl. CPC G06T 13/40

(57) ABSTRACT

A method for generating a subject avatar using a mobile phone scan is provided. The method includes receiving, from a mobile device, multiple images of a first subject, extracting multiple image features from the images of the first subject based on a set of learnable weights, inferring a three-dimensional model of the first subject from the image features and an existing three-dimensional model of a second subject, animating the three-dimensional model of the first subject based on an immersive reality application running on a headset used by a viewer, and providing, to a display on the headset, an image of the three-dimensional model of the first subject. A system and a non-transitory, computer-readable medium storing instructions to perform the above method, are also provided.

### CROSS-REFERENCE TO RELATED APPLICATIONS

The present disclosure is related and claims priority under 35 U.S.C. § 119(e) to U.S. Prov. Appln. No. 63/305,614, filed on Feb. 1, 2022, and to U.S. Prov. Appln. No. 63/369,916, filed Jul. 29, 2022 both entitled AUTHENTIC VOLUMETRIC AVATARS FROM A PHONE SCAN, to Chen CAO, et-al., the contents of which are hereby incorporated by reference in their entirety, for all purposes.

### BACKGROUND

### Technical Field

The present disclosure is related to generating faithful facial expressions for generating real-time volumetric avatars in virtual reality (VR) and augmented reality (AR) applications. More specifically, the present disclosure provides real-time volumetric avatars for VR/AR applications using a phone scan.

### Related Art

In the field of VR/AR applications, acquisition and rendering of photo-realistic human heads is a challenging problem for achieving virtual telepresence. Currently, the highest quality is achieved by volumetric approaches trained in a person-specific manner on multi-view data. These models better represent fine structure, such as hair, compared to simpler mesh-based models. However, the collection of images for training neural network models to generate the models is a long and expensive process, which requires large amounts of time of exposure to the subject of the avatar.

### SUMMARY

In a first embodiment, a computer-implemented method includes receiving, from a mobile device, multiple images of a first subject, extracting multiple image features from the images of the first subject based on a set of learnable weights, inferring a three-dimensional model of the first subject from the image features and an existing three-dimensional model of a second subject, animating the three-dimensional model of the first subject based on an immersive reality application running on a headset used by a viewer, and providing, to a display on the headset, an image of the three-dimensional model of the first subject.

In a second embodiment, a system includes a memory storing multiple instructions and one or more processors configured to execute the instructions to cause the system to perform operations. The operations include to receive, from a mobile device, multiple images of a first subject, to extract multiple image features from the images of the first subject based on a set of learnable weights, to imprint the image features onto a three-dimensional model of a second subject stored in a database to form a three-dimensional model of the first subject, to animate the three-dimensional model of the first subject based on an immersive application running on a headset used by a viewer; and to provide, to a display on the headset, an image of the three-dimensional model of the first subject.

In a third embodiment, a computer-implemented method for training a model to provide a view of a subject in a virtual reality headset includes collecting, from a face of multiple subjects, multiple images according to a capture script, updating an identity encoder and an expression encoder in a three-dimensional face model, generating, with the three-dimensional face model, a synthetic view of a user along a pre-selected direction corresponding to a view of the user, and training the three-dimensional face model based on a difference between an image of the user provided by a mobile device, and the synthetic view of the user.

In another embodiment, a non-transitory, computer-readable medium storing instructions is provided. When one or more processors in a computer execute the instructions, the computer executes a method. The method includes receiving, from a mobile device, multiple images of a first subject, extracting multiple image features from the images of the first subject based on a set of learnable weights, inferring a three-dimensional model of the first subject from the image features and an existing three-dimensional model of a second subject, animating the three-dimensional model of the first subject based on an immersive reality application running on a headset used by a viewer, and providing, to a display on the headset, an image of the three-dimensional model of the first subject.

In yet another embodiment, a system includes a first means to store instructions and a second means to execute the instructions to cause the system to perform a method. The method includes receiving, from a mobile device, multiple images of a first subject, extracting multiple image features from the images of the first subject based on a set of learnable weights, inferring a three-dimensional model of the first subject from the image features and an existing three-dimensional model of a second subject, animating the three-dimensional model of the first subject based on an immersive reality application running on a headset used by a viewer, and providing, to a display on the headset, an image of the three-dimensional model of the first subject.

These and other embodiments will become clear to one of ordinary skill in the art in view of the following disclosure.

### BRIEF DESCRIPTION OF THE FIGURES

FIG. 1 illustrates an example architecture suitable for providing a real-time, clothed subject animation in a virtual reality environment, according to some embodiments.

FIG. 2 is a block diagram illustrating an example server and client from the architecture of FIG. 1, according to certain aspects of the disclosure.

FIGS. 3A-3C illustrate a block diagram of a model architecture used for obtaining a subject avatar from a phone scan, according to some embodiments.

FIGS. 4A-4B illustrate partial views of an architecture diagram for a universal prior model used for obtaining a subject avatar from a phone scan, according to some embodiments.

FIG. 5 illustrates a studio for collecting multi-illumination, multi-view images of a subject for the universal prior model, according to some embodiments.

FIG. 6 illustrates multiple images collected in the studio of FIG. 5, according to some embodiments.

FIG. 7 illustrates a mobile phone user taking a self-scan video for uploading to a system that generates a photorealistic avatar of the user, according to some embodiments.

FIG. 8 illustrates conditioning data acquisition for creating a 3D model of a subject's face, according to some embodiments.

FIG. 9 illustrates personalized decoders including a reconstructed mesh and an aggregated texture for rendering a subject avatar from input images, according to some embodiments.

FIG. 10 illustrates a loss function effect for high fidelity avatars, according to some embodiments.

FIG. 11 illustrates an expression consistent latent space provided by a universal prior model, according to some embodiments.

FIG. 12 illustrates an expression retargeting function and results, according to some embodiments.

FIG. 13 illustrates identity invariant results from an expression latent space, according to some embodiments.

FIG. 14 illustrates explicit gaze control via a disentangled representation, according to some embodiments.

FIG. 15 illustrates fine-tunning avatar models with and without an identity latent space of different spatial resolutions, according to some embodiments.

FIG. 16 illustrates the performance of universal prior models, according to some embodiments.

FIG. 17 illustrates ablation procedures on losses used in fine-tuning, according to some embodiments.

FIG. 18 illustrates the effect of fine-tuning a dataset size on performance on different parts of the model, according to some embodiments.

FIG. 19 illustrates the effect of a learning rate on fine-tuning, according to some embodiments.

FIG. 20 illustrates a comparison of avatars created from a multi-view studio modeling and from a mobile phone scan, according to some embodiments.

FIG. 21 illustrates a comparison of avatars created from a mobile phone scan before and after fine-tuning, according to some embodiments.

FIG. 22 illustrates avatars created from a mobile phone scan including glasses and long hair, according to some embodiments.

FIG. 23 illustrates refined personalized avatars, according to some embodiments.

FIG. 24 illustrates personalized avatars imprinted on different subjects from images of a first model subject, according to some embodiments.

FIG. 25 is a flow chart illustrating steps in a method for providing a video scan to a remote server to create a subject avatar, according to some embodiments.

FIG. 26 is a flow chart illustrating steps in a method for generating a subject avatar from a video scan provided by the subject, according to some embodiments.

FIG. 27 is a block diagram illustrating components in a computer system for performing methods as disclosed herein, according to some embodiments.

In the figures, like elements are labeled likewise, according to their description, unless explicitly stated otherwise.

### DETAILED DESCRIPTION OF THE FIGURES

In the following detailed description, numerous specific details are set forth to provide a full understanding of the present disclosure. It will be apparent, however, to one ordinarily skilled in the art, that embodiments of the present disclosure may be practiced without some of these specific details. In other instances, well-known structures and techniques have not been shown in detail so as not to obscure the disclosure.

General Overview

Creating photorealistic avatars of existing people currently requires extensive person-specific data capture, which is usually only accessible to the visual-effects industry and not the general public. Accordingly, traditional methods rely on extensive person-specific data captures as well as artist-driven manual processing that is costly and time consuming. Automating the avatar creation process, with lightweight data capture, low latency, and acceptable quality, is thus, highly desirable. The core challenge of automatic avatar creation from limited data lies in the trade-off between prior and evidence. A prior is desirable to complement the limited information about a person's appearance, geometry, and motion that can be acquired in a light-weight way (e.g., using a mobile phone camera). However, despite significant progress in recent years, learning the manifold of human faces at high resolution remains challenging. Modeling long tails of the distribution, which is desirable for capturing personal idiosyncrasies like specific freckles, tattoos, or scars, likely requires models with much higher dimensional latent spaces, and consequently, much more data than what is currently used to train such models. Modern approaches are capable of hallucinating plausible non-existing faces but fail to generate representations of real people at a fidelity that makes them recognizable as themselves. Some approaches achieve good inverse reconstruction by optimizing outside of a latent space, where there are no guarantees about the model behavior, but resulting in strong artifacts in their image translation results.

While recent advances in generative face modeling have been shown to plausibly hallucinate detailed appearance of non-existing people, they can fail to span the detailed appearance of a particular unseen real person, possibly stemming from the low-dimensional latent spaces they employ. The result is a similar-looking, but recognizably different, identity.

To solve the above problems in the field of immersive reality applications for computer networks, embodiments as disclosed herein implement a short mobile phone capture to obtain a drivable 3D head avatar that matches a person's likeness faithfully. In contrast to existing approaches, architectures disclosed herein avoid the complex task of directly modeling the entire manifold of human appearance, aiming instead to generate an avatar model that can be specialized to novel identities using only small amounts of data. In some embodiments, models may use low-dimensional latent spaces commonly employed for hallucinating novel identities. In yet other embodiments, avatar models may use a conditional representation that can extract person-specific information at multiple scales from a high resolution registered neutral phone scan. These models achieve high quality results through a universal prior model that is trained on high resolution multi-view video captures of facial performances of hundreds of human subjects. By fine-tuning the universal prior model using inverse rendering, embodiments disclosed herein achieve increased realism and personalize a range of motion. The output is not only a high-fidelity 3D head avatar that matches the person's facial shape and appearance, but one that can also be driven using a shared global expression space with disentangled controls for gaze direction. Avatars generated with models as disclosed herein are faithful representations of the subject's likeness. Comparisons with multiple avatar models, the lightweight approach disclosed herein, exhibits superior visual quality and animation capability.

Embodiments as disclosed herein avoid generating hallucinating non-existing people, and instead, specialize for adaptation using easily acquired mobile phone data of real people. Some of the features include a universal prior including a hypernetwork trained on a high-quality corpus of multi-view video of hundreds of identities. Some of the features also include a registration technique for conditioning the model on a mobile phone scan of the user's neutral expression. Some embodiments include an inverse rendering-based technique to fine-tune the personalized model on additional expressive data. The inverse-rendering technique specializes the avatar's expression space to the user, given additional frontal mobile phone captures, while ensuring the viewpoint's generalizability and preserving the latent space's semantics.

A universal prior architecture is based on the observation that long tail aspects of facial appearance and structure lie in details that are best extracted directly from conditioning data of a person instead of reconstructed from low-dimensional identity embeddings. The performance of low-dimensional embeddings plateaus quickly, failing to capture person-specific idiosyncrasies. Instead, embodiments as disclosed herein augment existing approaches with person-specific multi-scale ‘untied’ bias maps that can faithfully reconstruct the high level of detail specific to a person. These bias maps can be generated from unwrapped texture and geometry of a user's neutral scan using a U-Net-style network. In this way, some embodiments include a hypernetwork that takes in data of a user's neutral face and produces parameters for a personalized decoder in the form of bias maps. The resulting avatar has a consistent expression latent space with disentangled controls for viewpoint, expression, and gaze direction. The model is robust against real-world variations in the conditioning signal, including variations due to lighting, sensor noise, and limited resolution.

An important feature of a universal prior architecture as disclosed herein is the consistency of the controls for downstream tasks. Accordingly, the universal prior architecture creates highly realistic avatars in real time from a single neutral scan (e.g., from a mobile phone). In addition, embodiments as disclosed herein produce models that span a person's expressive range with additional frontal mobile phone captures of only a few expressions.

Embodiments as disclosed herein generate subject avatars from mobile phone captures without significantly increasing requirements on the user end. Whereas existing methods can produce plausible hallucinations of people, our approach produces avatars that look and move like a specific person. Furthermore, models as disclosed herein inherit the speed, resolution, and rendering quality of an existing person-specific model, since it employs a similar architecture and rendering machinery. Thus, it is well suited for interactive framerate-demanding applications such as VR. This opens the possibility for ubiquitous photorealistic telepresence in VR that has thus far been hindered by the heavy requirements for avatar creation, or the low quality of avatars produced by lightweight captures.

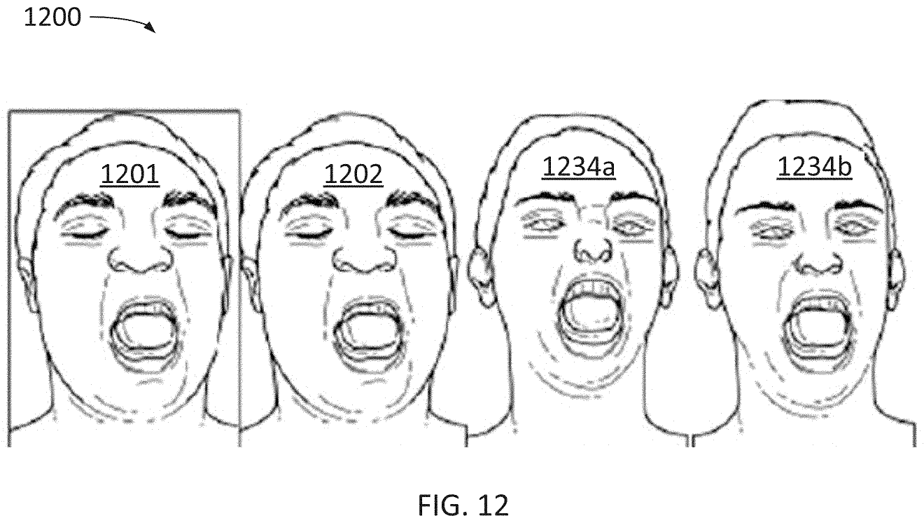

For attributes with a physical meaning, such as gaze direction, a UPM as disclosed herein can disentangle their effects from the rest of the expression space, enabling their direct control from external sensors in a VR/AR headset (e.g., eye tracking) without disturbing the rest of the expression. Some examples of this are shown in FIG. 12, where expression retargeting is performed as above, but the gaze direction is modified.

UPM models disclosed herein achieve the above results through the combination of bias maps for personalization, a fully convolutional 4×4×16 expression latent space, and neutral-differencing the input to the expression encoder. UPM models as disclosed herein produce more fine-scale detail, especially in dynamic areas like the mouth. Some UPM models disclosed herein correct for overfitting by training to anticipate the fine-tuning process. Some embodiments include meta-learning to do this. Similar strategies may reduce the number of fine-tuning iterations used to obtain desirable results, as well as reduce overfitting problems when fine-tuning data is sparse.

In some embodiments, a UPM combines the RGB images with depth, D, data from a studio session, and applies them to held-out data of the same subject. The resulting UPM can then be fed mobile phone data from any given subject to generate real-time, accurate subject avatars, as disclosed herein.

Broad ranging UPMs are provided by collecting a corpus with more variation in terms of illumination and clothing and other configurations including full bodies, hands or challenging hair styles. To address these configurations, easy-to-follow capture scripts are developed (in studio or via mobile phone) to obtain appropriate conditioning data. To consider loose clothing and long hair secondary dynamics and interpenetration are incorporated into UPMs as disclosed herein.

### Example System Architecture

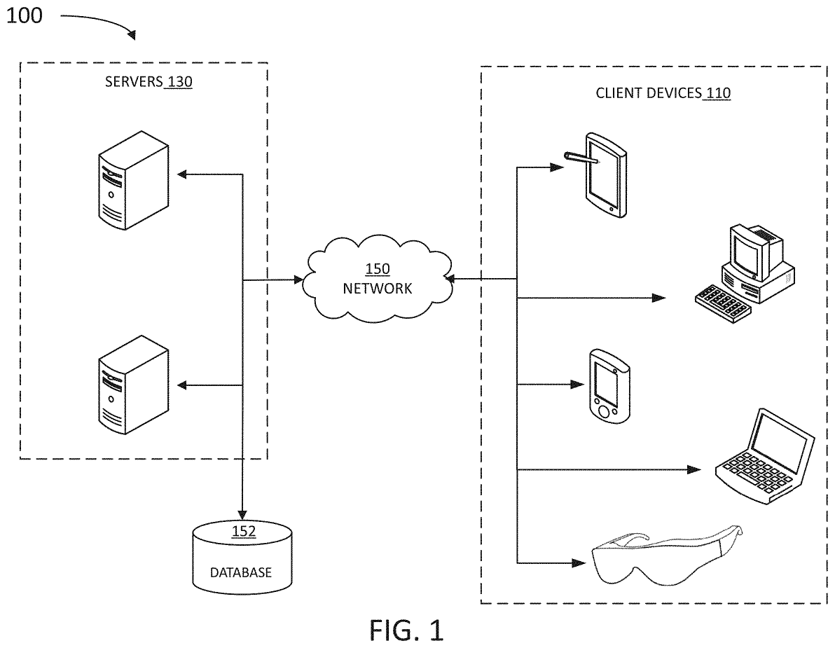

FIG. 1 illustrates an example architecture 100 suitable for accessing a volumetric avatar engine, according to some embodiments. Architecture 100 includes servers 130 communicatively coupled with client devices 110 and at least one database 152 over a network 150. One of the many servers 130 is configured to host a memory including instructions which, when executed by a processor, cause the server 130 to perform at least some of the steps in methods as disclosed herein. In some embodiments, the processor is configured to control a graphical user interface (GUI) for the user of one of client devices 110 accessing the volumetric avatar model engine with an immersive reality application. Accordingly, the processor may include a dashboard tool, configured to display components and graphic results to the user via the GUI. For purposes of load balancing, multiple servers 130 can host memories including instructions to one or more processors, and multiple servers 130 can host a history log and a database 152 including multiple training archives used for the volumetric avatar model engine. Moreover, in some embodiments, multiple users of client devices 110 may access the same volumetric avatar model engine to run one or more immersive reality applications. In some embodiments, a single user with a single client device 110 may provide images and data to train one or more machine learning models running in parallel in one or more servers 130. Accordingly, client devices 110 and servers 130 may communicate with each other via network 150 and resources located therein, such as data in database 152.

Servers 130 may include any device having an appropriate processor, memory, and communications capability for hosting the volumetric avatar model engine including multiple tools associated with it. The volumetric avatar model engine may be accessible by various clients 110 over network 150. Clients 110 can be, for example, desktop computers, mobile computers, tablet computers (e.g., including e-book readers), mobile devices (e.g., a smartphone or PDA), or any other device having appropriate processor, memory, and communications capabilities for accessing the volumetric avatar model engine on one or more of servers 130. In some embodiments, client devices 110 may include VR/AR headsets configured to run an immersive reality application using a volumetric avatar model supported by one or more of servers 130. Network 150 can include, for example, any one or more of a local area tool (LAN), a wide area tool (WAN), the Internet, and the like. Further, network 150 can include, but is not limited to, any one or more of the following tool topologies, including a bus network, a star network, a ring network, a mesh network, a star-bus network, tree or hierarchical network, and the like.

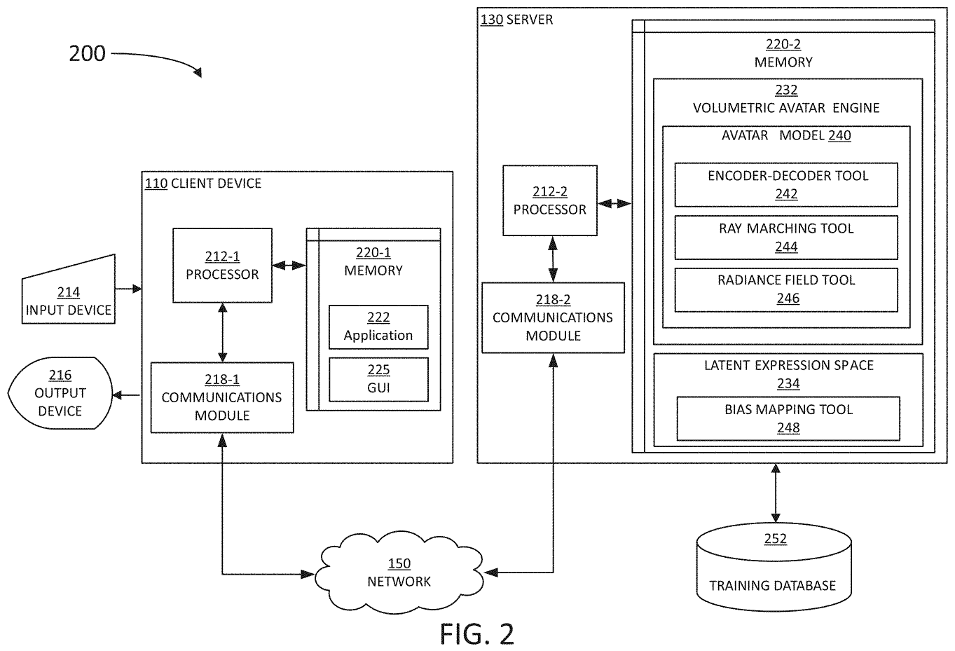

FIG. 2 is a block diagram 200 illustrating an example server 130 and client device 110 from architecture 100, according to certain aspects of the disclosure. Client device 110 and server 130 are communicatively coupled over network 150 via respective communications modules 218-1 and 218-2 (hereinafter, collectively referred to as “communications modules 218”). Communications modules 218 are configured to interface with network 150 to send and receive information, such as data, requests, responses, and commands to other devices via network 150. Communications modules 218 can be, for example, modems or Ethernet cards, and may include radio hardware and software for wireless communications (e.g., via electromagnetic radiation, such as radiofrequency—RF-, near field communications—NFC-, Wi-Fi, and Bluetooth radio technology). A user may interact with client device 110 via an input device 214 and an output device 216. Input device 214 may include a mouse, a keyboard, a pointer, a touchscreen, a microphone, a joystick, a virtual joystick, and the like. In some embodiments, input device 214 may include cameras, microphones, and sensors, such as touch sensors, acoustic sensors, inertial motion units -IMUs- and other sensors configured to provide input data to a VR/AR headset. For example, in some embodiments, input device 214 may include an eye tracking device to detect the position of a user's pupil in a VR/AR headset. Output device 216 may be a screen display, a touchscreen, a speaker, and the like. Client device 110 may include a memory 220-1 and a processor 212-1. Memory 220-1 may include an application 222 and a GUI 225, configured to run in client device 110 and couple with input device 214 and output device 216. Application 222 may be downloaded by the user from server 130 and may be hosted by server 130. In some embodiments, client device 110 is a VR/AR headset and application 222 is an immersive reality application. In some embodiments, client device 110 is a mobile phone that subjects use to self-scan a video or picture of themselves and upload to server 130 using a video or image collection application 222, to create an avatar of themselves, in real time.

Server 130 includes a memory 220-2, a processor 212-2, and communications module 218-2. Hereinafter, processors 212-1 and 212-2, and memories 220-1 and 220-2, will be collectively referred to, respectively, as “processors 212” and “memories 220.” Processors 212 are configured to execute instructions stored in memories 220. In some embodiments, memory 220-2 includes a volumetric avatar model engine 232 and a latent expression space 234. Volumetric avatar model engine 232 and latent expression space 234 may share or provide features and resources to GUI 225, including multiple tools associated with training and using a three-dimensional avatar rendering model for immersive reality applications (e.g., application 222). The user may access volumetric avatar model engine 232 and latent expression space 234 through application 222, installed in a memory 220-1 of client device 110. Accordingly, application 222, including GUI 225, may be installed by server 130 and perform scripts and other routines provided by server 130 through any one of multiple tools. Execution of application 222 may be controlled by processor 212-1.

In that regard, volumetric avatar model engine 232 may be configured to create, store, update, and maintain an avatar model 240, as disclosed herein. Avatar model 240 may include an encoder-decoder tool 242, a ray marching tool 244, and a radiance field tool 246. Encoder-decoder tool 242 collects input images of a subject and extracts pixel-aligned features to condition radiance field tool 246 via a ray marching procedure in ray marching tool 244. In some embodiments, the images are multi-view, multi-lighting images collected in a specialized studio, or may be a sequence of 2D or stereo images collected by the subject in a self-posing video with a mobile phone. Encoder-decoder tool 242 may include an expression encoding tool, an identity encoding tool, and a volumetric decoding tool, as disclosed herein. Avatar model 240 can generate novel views of unseen subjects from one or more sample images processed by encoder-decoder tool 242. In some embodiments, encoder-decoder tool 242 is a shallow (e.g., including a few one- or two-node layers) convolutional network. In some embodiments, radiance field tool 246 converts three-dimensional location and pixel-aligned features into color and opacity fields that can be projected in any desired direction of view.

In some embodiments, volumetric avatar model engine 232 may access one or more machine learning models stored in a training database 252. Training database 252 includes training archives and other data files that may be used by volumetric avatar model engine 232 in the training of a machine learning model, according to the input of the user through application 222. Moreover, in some embodiments, at least one or more training archives or machine learning models may be stored in either one of memories 220, and the user may have access to them through application 222.

Volumetric avatar model engine 232 may include algorithms trained for the specific purposes of the engines and tools included therein. The algorithms may include machine learning or artificial intelligence algorithms making use of any linear or non-linear algorithm, such as a neural network algorithm, or multivariate regression algorithm. In some embodiments, the machine learning model may include a neural network (NN), a convolutional neural network (CNN), a generative adversarial neural network (GAN), a deep reinforcement learning (DRL) algorithm, a deep recurrent neural network (DRNN), a classic machine learning algorithm such as random forest, k-nearest neighbor (KNN) algorithm, k-means clustering algorithms, or any combination thereof. More generally, the machine learning model may include any machine learning model involving a training step and an optimization step. In some embodiments, training database 252 may include a training archive to modify coefficients according to a desired outcome of the machine learning model. Accordingly, in some embodiments, volumetric avatar model engine 232 is configured to access training database 252 to retrieve documents and archives as inputs for the machine learning model. In some embodiments, volumetric avatar model engine 232, the tools contained therein, and at least part of training database 252 may be hosted in a different server that is accessible by server 130 or client device 110.

Latent expression space 234 includes a bias mapping tool 248 and provides an expression code that is configured to imprint generic expressions trained on and stored in latent expression space 234 onto a 3D mesh and a texture map for a specific subject. The 3D mesh and texture maps from the specific subject may be provided by a simple mobile phone scan (e.g., client device 110) uploaded by the subject onto server 130.

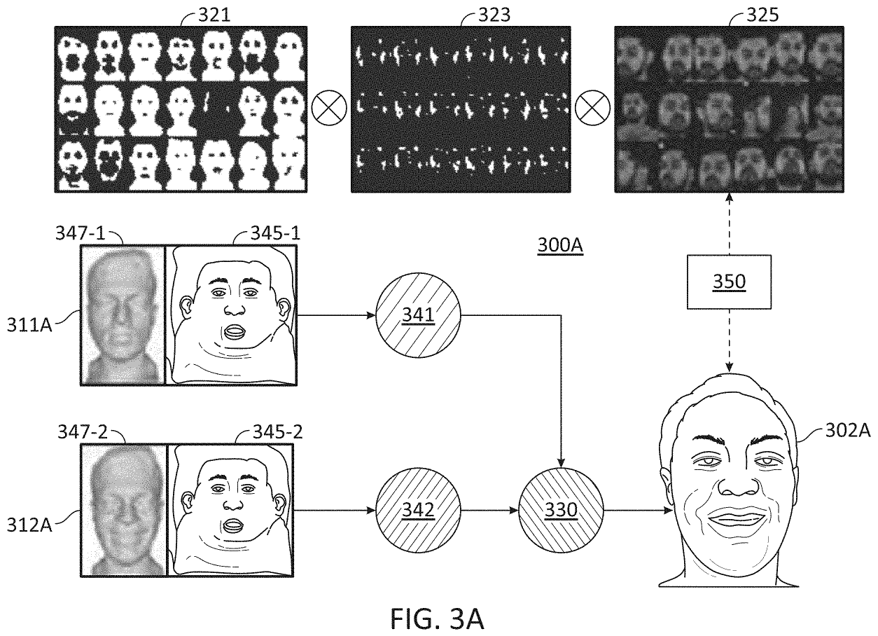

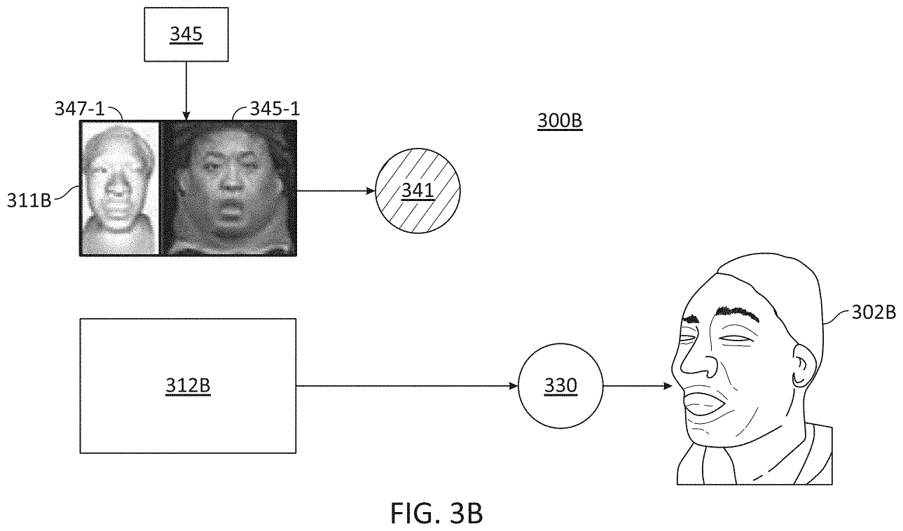

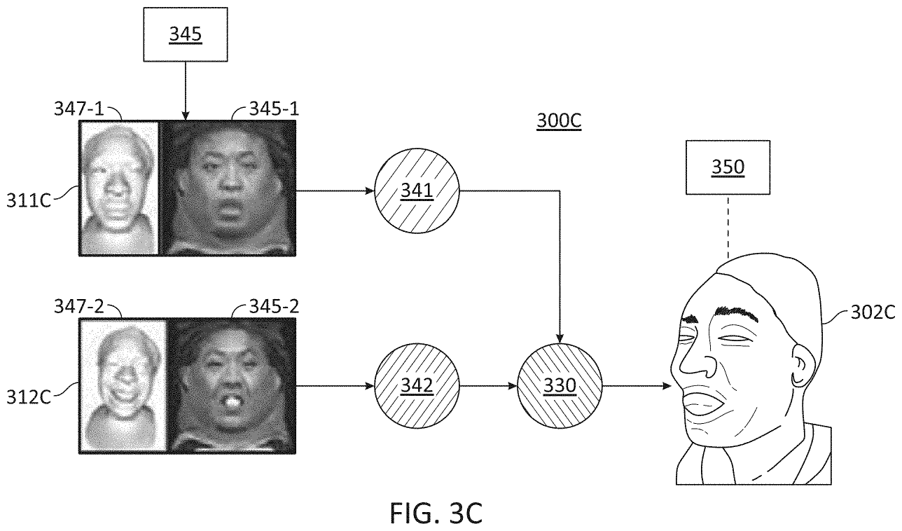

FIGS. 3A-3C illustrate block diagrams 300A, 300B, and 300C (hereinafter, collectively referred to as “block diagrams 300”) of a model architecture used for obtaining subject avatars 302A, 302B, and 302C (hereinafter, collectively referred to as “avatars 302”) from a phone scan, according to some embodiments. A universal prior model (UPM) training 300A is followed by a personalization stage (using a mobile phone scan over a neutral facial expression) 300B and an expression personalization stage (using a mobile phone over an expressive gesture) 300C. The architecture encompassed by block diagrams 300 trains a cross-identity hypernetwork 330 as a prior for generating avatars 302 that can be specialized to specific individuals by conditioning on a lightweight capture of that person's neutral expression. Avatars 302 are generated after a loss operation 350. Hypernetwork 330 collects neutral data 311A, 311B, and 311C (hereinafter, collectively referred to as “neutral data 311”) with an identity encoder 341 and expression data 312A, 312B, or 312C (hereinafter, collectively referred to as “expression data 312”) with an expression encoder 342, to generate avatars 302. Neutral data 311 includes a texture map 345-1 and a 3D mesh 347-1 with the subject having a neutral expression. Expression data 312 includes a texture map 345-2 and a 3D mesh 347-2 with the subject having an overly expressive gesture (e.g., laughter, grimace, anxious look, horror, and the like). Texture maps 345-1 and 345-2 will be collectively referred, hereinafter, as “texture maps 345.” And 3D meshes 347-1 and 347-2 will be collectively referred to, hereinafter, as “3D meshes 347.”

In block 300A, expression data 312A is retrieved from a pool of multiple identities 321, multiple frames 323 for each identity, and multiple views 325 for each frame and identity. In blocks 300B and 300C, a tracking and unwrapping tool 345 collects images from the mobile phone scan to generate neutral data 311B-C, and expression data 312B-C. Neutral data 311 and expression data 312 may include a 3D model or mesh, and a texture wrap, or surface to place over the 3D mesh to complete 3D avatars 302.

Finally, to account for person-specific details of expressions that are difficult to model using a cross identity prior (block 300A), or universal expression codes 312B, refining block 300C uses unstructured captures of a specific individual via the inverse rendering method to obtain an individualized, expressive avatar 302C.

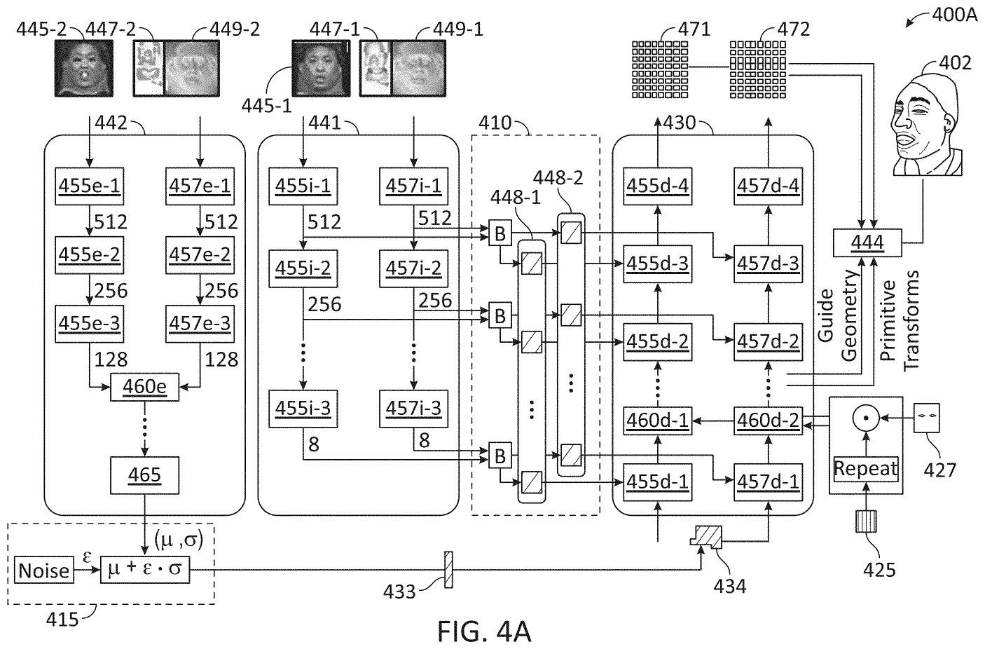

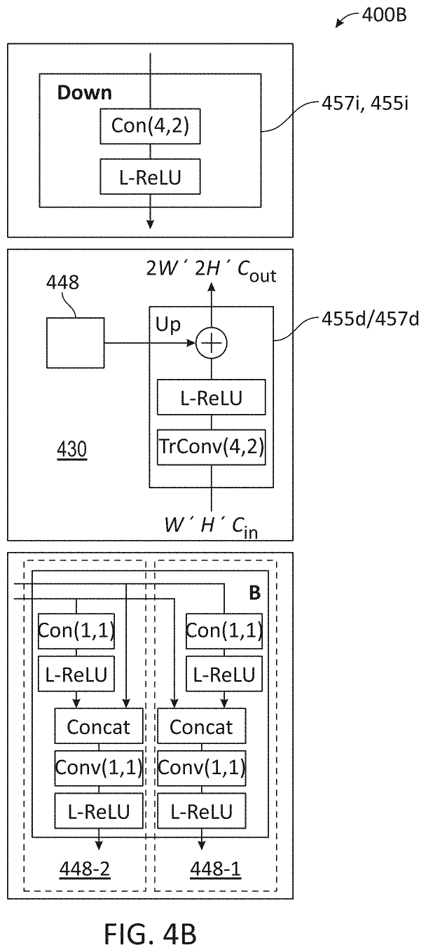

FIGS. 4A and 4B illustrate partial views of an architecture for a UPM 400 used for obtaining a subject avatar 402 from a phone scan, according to some embodiments. UPM 400 is a hypernetwork that generates parameters for a person-specific mixture of volumetric primitives (MVP)-based avatar that can be animated. Person-specific avatars achieve a high degree of likeness to the target identity largely from the use of ‘untied’ bias maps 448-1 (e.g., application bias) and 448-2 (e.g., geometric bias, hereinafter, collectively referred to as “bias maps 448,” Φ_{id}) in an identity conditioning block 410. The simplest form of this is the base texture and geometry used in classical avatar representations that capture static details such as freckles, moles, wrinkles, and even tattoos and small accessories like ear- and nose-rings. Thus. UPM 400 has the ability to generate bias maps 448 for real unseen identities. To generate avatars of real people. UPM 400 extracts person-specific bias maps 448 from conditioning data of real people. Person-specific bias maps 448 enable a compute-once-use-often setting for live facial animation. This avoids entanglement between the architecture for expression and identity, relieving computation resources for animation purposes. In some embodiments, UPM 400 uses a U-net architecture from 2D conditioning data to volumetric slabs, which can be ray marched (e.g., via ray marching tool 244) to generate photorealistic avatar 402. According to architecture 400A. UPM 400 includes an identity encoder 441 (E_{id}), an expression encoder 442 (Eₑₓₚ), and a person-specific decoder 430.

In some embodiments, E_{id} 441 uses strided convolutions to extract person-specific information from the conditioning data in the form of (1024×1024) texture 445-1 and geometric 447-1 maps (combined into maps 449-1 or 449-2) of a subject's neutral expression. E_{id} 441 includes down-sampling blocks 455i-1, 455i-2, 455i-3, 457i-1, 457i-2, and 457i-3 (hereinafter, collectively referred to as “down-sampling blocks 455i and 457i,” respectively, and “down-sampling blocks 455 and 457,” collectively for Eₓₚ 442 and E_{id} 441).

Eₑₓₚ 442 extracts expression latent codes, e, for each sample in the training set. For this we employ a fully convolutional variational network that takes view-averaged expressive texture 445-2 and position 447-2 maps (combined into maps 449-2) as input. Eₑₓₚ 442 includes down-sampling blocks 455e-1, 455e-2, 455e-3, 457e-1, 457e-2, and 457e-3 (hereinafter, collectively referred to as “down-sampling blocks 455e and 457e,” respectively). In some embodiments, view-averaged input removes view-dependent effects, relaxing the need to use of the view-conditioning at the bottleneck to enable explicit control. In some embodiments, a (4×4×16) latent code 433 produces the mean and variances at that resolution. Down sampling blocks 455e and 457e are concatenated 465e and further down-sampled 460 into a statistics stage 415 that adds random noise, c, to a mean, p, and a standard deviation, a, of the processed blocks. To promote the formation of a semantically consistent expression latent space 434, neutral texture and position maps 445-1 and 447-1 are subtracted from their expressive counterparts before inputting them into decoder 430. This avoids identity information leaking into expression latent space 434 without additional adversarial terms.

Decoder 430 includes up-sampling blocks 455d-1, 455d-2, 455d-3, 455d-4, 457d-1, 457d-2, 457d-3, and 457d-4 (collectively referred to, hereinafter, as “up-sampling blocks 455d and 457d”).

To enable the extraction of person-specific details, E_{id} 441 takes conditioning information in the form of a neutral texture map 445-1 (Tₙₑᵤ), and a neutral geometry image 447-1 (an xyz-position map, or 3D mesh Gₙₑᵤ), and produces bias maps 448 for each level of V via a set of skip connections. UPM 400 is trained to reconstruct a multi-view dataset of multiple identities 471 with multiple expressions each. Eₑₓₚ 442 generates an expression code 433 (e). Eₑₓₚ 442 generates view-averaged texture 445-2 (Tₑₓₚ) and geometric 447-2 (Gₑₓₚ) for a particular expression frame, as input. In summary, UPM 400 can be written as:

e=Eₑₓₚ(ΔTₑₓₚ,ΔGₑₓₚ,Φₑₓₚ) (1)

θ_{id}=E_{id}(T_{new},Gₙₑᵤ,Φ_{id}) (2)

[symbol]

=D(e,ν,g;θ_{id},Φ_{dec}) (3)

where ΔTₑₓₚ=Tₑₓₚ−Tₙₑᵤ, ΔGₑₓₚ=Gₑₓₚ-Gₙₑᵤ, and M are the output volumetric primitives for ray-marching 444 (e.g., from ray marching tool 244), and Φₑₓₚ, and Φ_{id}, are trainable parameters for Eₑₓₚ 442 and E_{id} 441, respectively. Decoder 430 is also conditioned on view and gaze direction vectors, v and g, used for rendering, to allow explicit control over gaze and view-dependent appearance changes. Parameters in decoder 430 include two parts: 1) trainable network weights, Φ_{dec}, that model identity independent information that is shared across different identities, and 2) Φ_{id} 448, which are regressed by the identity encoder and capture person specific information.

Decoder 430 includes two deconvolutional networks, V_{geo} (up-sampling blocks 457d) and Vₐₚₚ (up-sampling blocks 455d), that produce opacity slab 472 (1024×1024×8) and appearance slab 471 (1024×1024×24), as well as sparse guide geometry and transformations that are used to place the volumetric primitives in world space for ray-marching (cf. ray marching tool 244). A convolutional expression latent space 434 (dimensions R^{4×4×16}) spatially localizes the effect of each latent dimension. This promotes semantic consistency of expression latent space 434 across identities, which is important for downstream tasks such as expression transfer. In some embodiments, UPM 400 disentangles a gaze 425 from expression latent space 434 by replicating encodings of (2×3) gaze direction into an (8×8) grid 427, masking these tensors to zero-out unrelated spatial regions, and conditioning decoder 430 by concatenating, in stages 460d-1 and 460d-2 (hereinafter, collectively referred to as “concatenation stages 460d”), at grid 427 level (e.g., up-sampling blocks 455d-1 and 457d-1), before continuing to decode to higher resolutions. To enable explicit control of view-dependent factors based on a viewer's vantage point in the scene. UPM 400 enables explicit estimates of gaze 425 to be directly used to control avatar 402. Accordingly, gaze 425 includes view dependent factors to support functions such as varifocal adjustments and foveated rendering for VR applications. As a result, in some embodiments, UPM 400 explicitly disentangles gaze 425 from the rest of facial motion and leverages in-built eye tracking systems more directly.

A detailed view 400B of decoder 430 includes convolutional up-sampling blocks 455d and 457d with bias maps 448, one bias per output activation. Let Cᵢₙ and Cₒᵤₜ be the number of input and output channels up-sampling layers (blocks 455d and 457d), and let W and H be the width and height of the input activations. Thus, the input to the layer is a feature tensor of size (W×H×Cᵢₙ), which is up-sampled to dimension (2 W×2H×Cₒᵤₜ). The up-sampling is implemented by a transpose convolution layer (no bias, 4×4 kernel, stride 2) and is followed by an addition with a bias map of dimension (2 W×2H×Cₒᵤₜ) produced by E_{id} 441.

Inputs 457i and 455i are processed separately using a convolution to increase the feature channels to 8, followed by eight strided convolution layers with L-ReLU activations, increasing the channel size each time. At each resolution level, the intermediate features of the geometry 457i and texture 455i branches are concatenated and further processed using convolution steps to produce bias map 448 for a given level 455d of decoder 430. When considering the pairs (455i, 455d), the architecture resembles a U-Net. This architecture simplifies the transfer high resolution detail from conditioning data (cf. maps 449) directly to a decoded output, allowing it to reproduce intricate person-specific details.

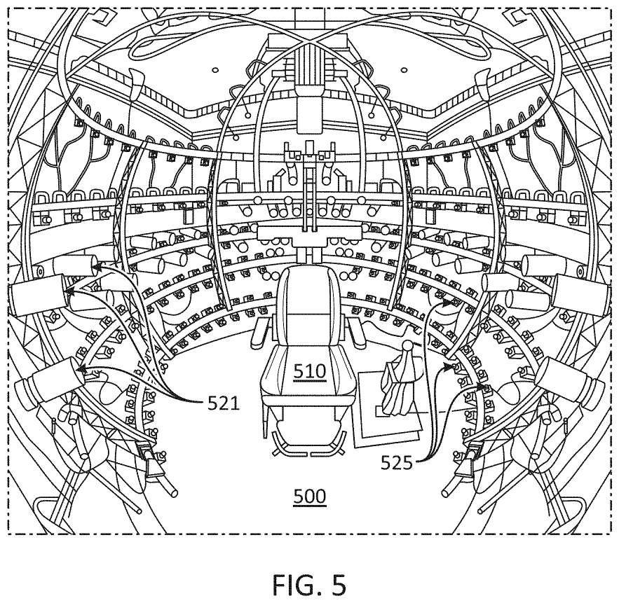

FIG. 5 illustrates a studio 500 (capture dome) for collecting multi-illumination, multi-view images of a subject for a UPM (e.g., UPM 400), according to some embodiments. Training of the UPM includes capture dome 500, a capture script, and a tracking pipeline. To capture synchronized multi-view videos of a facial performance, capture dome 500 includes multiple video cameras 525 (monochrome and polychrome cameras) placed on a spherical structure with a selected radius (e.g., 1.2 meters or more). Cameras 525 are pointed towards the center of the spherical structure where the subject's head is situated (the subject is seated on seat 510). In some embodiments, the video capture is collected at a resolution of 4096×2668 pixels with a shutter speed of 2.222 ms at 90 frames per second. Multiple (e.g., 350, or more) point light sources 521 are evenly distributed across the structure to uniformly illuminate the participant. To compute the intrinsic and extrinsic parameters of each camera 525, a robot arm includes a 3D calibration target to perform automatic geometric camera calibration.

A capture script systematically guides the subject through a wide range of facial expressions for each amount of time. The subjects are asked to go through the following exercises: 1) mimic 65 distinct facial expressions, 2) perform a free-form facial range-of-motion segment, 3) look in 25 different directions to represent various gaze angles, and 4) read 50 phonetically balanced sentences. In some embodiments, 255 subjects are captured, and an average of 12,000 subsampled frames were recorded per subject. Accordingly, 3.1 million frames are processed. For building the datasets, the capture script may be designed to span the range of facial expressions, as much as possible. Accordingly, UPM models can reproduce some rare or extreme expressions.

To generate tracked meshes for over 3.1 million frames, a two-phase approach includes training a high-coverage landmark detector that produces a set of 320 landmarks uniformly distributed across the subject's face. The landmarks cover both salient features (such as eye corners) as well as more uniform regions (such as the cheeks and forehead). For 30 subjects or so, a dense tracking on ˜6 k frames covers a variety of expressions followed by sampling landmark locations from the dense tracking results. In addition, for all 255 participants, a non-rigid iterative-closest-point-based face mesh fitting on 65 expressions and sampled landmark locations from the fitted meshes may be performed. The first source of data provides good expression coverage on a limited set of identities. The second source expands identity coverage. In a second phase, a high-coverage landmark detector runs multiple views of each frame. The detected landmarks are then used to initialize a Principal Component Analysis (PCA) model-based tracking method to produce the final tracked mesh.

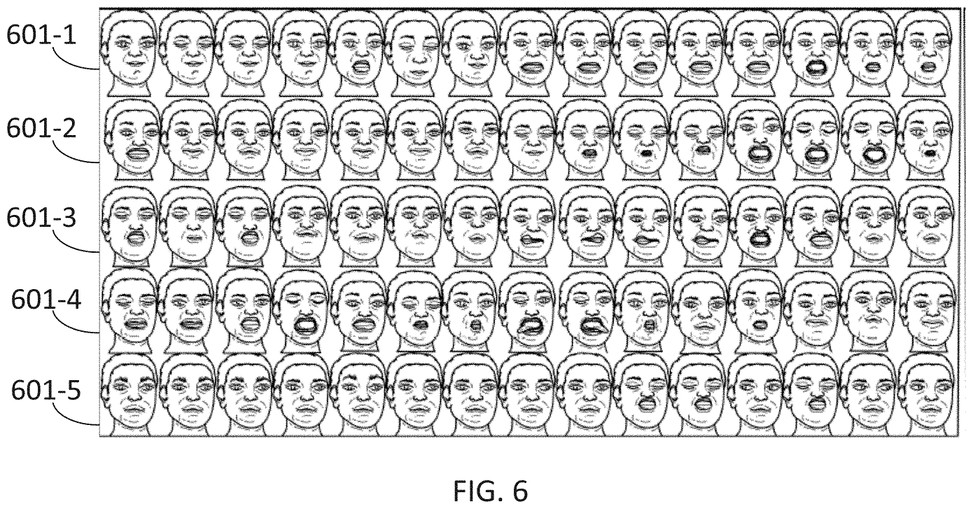

FIG. 6 illustrates multiple images 601-1, 601-2, 601-3, 601-4, and 601-5 (hereinafter, collectively referred to as input images 601) collected in the studio of FIG. 5, according to some embodiments. UPM parameters (Φₑₓₚ, Φ_{id}, Φ_{dec}, cf. Eqs.1-3) are optimized using:

$${Φ}^{*} = argmin ( Φ ) {\sum }_{i ∈ {N}_{I}} {\sum }_{f ∈ {N}_{{F}_{I}}} {\sum }_{c ∈ {N}_{C}} {ℒ}_{totaal} ( Φ ; {I}_{f}^{i , c} ) \qquad ( 4 )$$

over N₁ different identities, N_{Fi} frames, and N_{C} different camera views from input images 601. I^{i,c}_{f} denotes both the ground truth camera image as well as the set of training data associated with frame f. For example, the tracked geometry and corresponding geometry image Gₑₓₚ, the view-averaged texture Tₑₓₚ, camera calibration, tracked gaze direction, g, and a segmentation image (described below). A loss function, [symbol] ₜₒₜₐₗ, includes three main components:

[symbol]

ₜₒₜₐₗ(Φ;I_{f}^{i,c})= [symbol] _{rec}(Φ;I_{f}^{i,c})+ [symbol] ₘᵥₚ(Φ;I_{f}^{i,c})+ [symbol] _{seg}(Φ) (5)

Lₘᵥₚ are losses excluding photometric losses, and L_{rec} and L_{seg} are additions specific to a use case. The UPM is trained by optimizing Eq. 4 with a stochastic gradient descent and a learning rate of 10⁻³.

In some embodiments, UPM training includes finding reconstruction losses, [symbol] _{rec}, to ensure that the synthesized images match the ground truth. [symbol] _{rec} can be split into three different parts:

[symbol]

_{rec}(Φ;I_{f}^{i,c})= [symbol] ₚₕₒ(Φ;I_{f}^{i,c})+ [symbol] _{vgg}(Φ;I_{f}^{i,c})+ [symbol] _{gan}(Φ;I_{f}^{i,c}) (6)

[symbol] ₚₕₒ (Φ;I_{f}^{i,c}) is a pixel-wise photometric reconstruction loss that compares the synthesized images with the ground truth, pixel-by-pixel:

$${ℒ}_{pho} ( Φ ; {I}_{p} ) = {λ}_{pho} \frac{1}{{N}_{p}} {ρ}_{p ∈ P} {‖ {I}_{f}^{i , c} ( p ) - {\tilde{I}}_{f}^{i , c} ( p ) ‖}_{1} \qquad ( 7 )$$

Where P is a random sample of pixels and the weight of this term is λₚₕₒ=1. Eq. 7 uses an [symbol] ₁-norm for sharper reconstruction results. UPM training also estimates per-camera background images and color transformations for each identity (e.g., subject), and sample pixels over the entire image. The term [symbol] _{vgg}(Φ; I_{f}^{i,c}) in Eq. 6 is the VGG-loss that penalizes a difference between the low-level VGG feature maps of the synthesized and ground truth images. In particular, it is more sensitive to low-level perceptual features, such as edges, and thus leads to sharper reconstruction results. In some embodiments, the weight of this term may be λ_{vgg}=1. An adversarial loss, [symbol] _{gan} (Φ; I_{f}^{i,c}), in Eq. 6 is based on a patch-based discriminator for sharper reconstruction results and reduced hole-artifacts that can occur in MVP representations. In some embodiments, the weight of this term is λ_{gan}=0.1. Unlike [symbol] ₚₕₒ(Φ;I_{f}^{i,c}), the other two losses use a spatial receptive field to compute their values via convolutional architectures. As such, each pixel may not be independently evaluated of all others. In some embodiments, memory limitations may constrain training to lower resolution image. Thus, some training strategies randomly sample scaled and translated patches of (384×250) pixel resolution. Anti-aliased sampling on the full resolution images generates the ground truth patches, and sample rays corresponding to pixels in those patches selected with a ray marching tool (e.g., ray marching tool 244) reduce the computation burden substantially. This step is desirable for the L_{vgg} and L_{gan}, losses to capture details and avoid overfitting to features at a specific scale.

Segmentation losses, [symbol] _{seg}(Φ;Iₚ), in Eq. 5 promote better coverage of the subject in the scene, by penalizing the difference between a pre-computed foreground-background segmentation mask and the integrated opacity field of the rendered avatar along pixel rays:

$${ℒ}_{seg} ( Φ ; {I}_{p} ) = {λ}_{seg} \frac{1}{{N}_{p}} {\sum }_{p ∈ P} {‖ {O}_{f}^{i , c} ( p ) - {\tilde{S}}_{f}^{i , c} ( p ) ‖}_{1} \qquad ( 8 )$$

where S are the segmentation maps and O is the integrated opacity computed during ray marching. Including [symbol] _{seg}(Φ;Iₚ) in the UPM improves parts that are not well modeled by a guide geometry, such as a protruding tongue or hair structure that was not reconstructed accurately. In some embodiments, a weight value λ_{seg}=0.1 may be used initially, linearly reducing it to λ_{seg}=0.01 to include the missing parts.

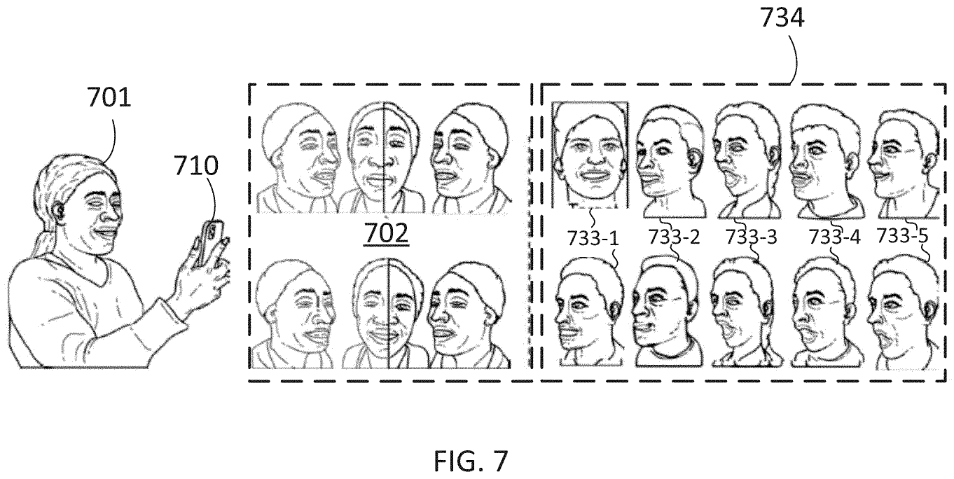

FIG. 7 illustrates a user 701 of a mobile phone 710 taking a self-scan video for uploading to a system that generates a photorealistic avatar 702 of the user, according to some embodiments. A target expression 733-1, 733-2, 733-3, 733-4, and 733-5 (hereinafter, collectively referred to as “target expressions 733”) may be imprinted in subject avatar 702 from a latent expression space 734. To build a personalized avatar, we capture two sets of user data using a mobile phone: 1) a multi-view scan of the user's neutral face used to condition the universal prior model, and 2) frontal views of 65 facial expressions.

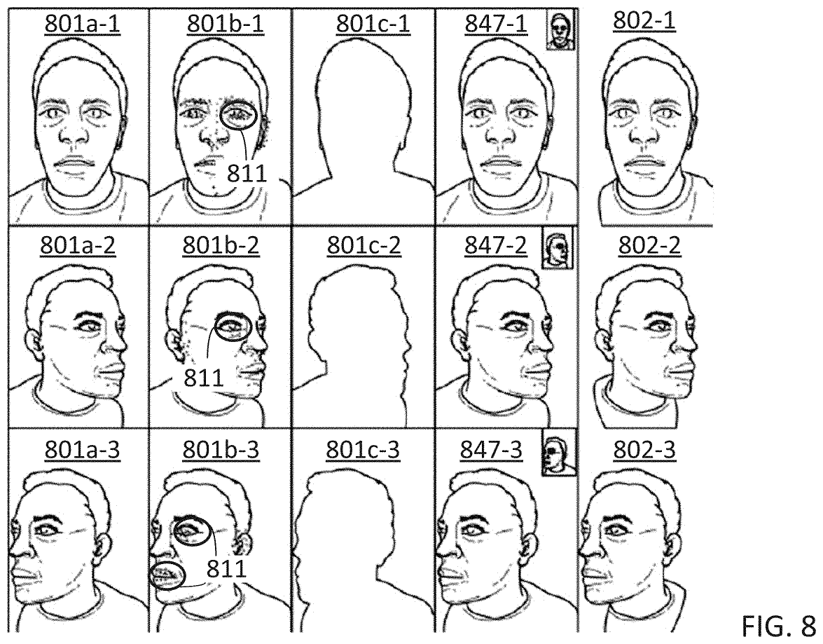

FIG. 8 illustrates conditioning data acquisition for creating 3D models of a subject's face 802-1, 802-2, and 802-3 (hereinafter, collectively referred to as “subject avatars 802”), according to some embodiments.

The conditioning data includes images 801a-1, 801a-2, and 801a-3 (hereinafter, collectively referred to as “conditioning data 801a”) for a UPM (e.g., UPM 400). To allow for broad adoption by users, a UPM as disclosed herein is configured to receive conditioning data 801a captured by widely available devices (e.g., a mobile phone, cell phone, or a smart phone) and a simple script of gestures and expressions that a user can follow by themselves. In some embodiments, the mobile phone incorporates a depth sensor that can be used to extract a 3D geometry of the user's face. For the capture script, the user is asked to maintain a fixed neutral expression while moving the phone around the user's head, left to right, then up and down, to acquire a complete capture of the entire head, including hair. In some circumstances, maintaining a static expression is challenging for untrained subjects. Accordingly, the script may include capturing additional expressions with a frontal camera only, without the need to maintain a static expression. Conditioning data 801a includes a subject's neutral face from different perspectives. For each captured image, we run a detector to obtain a set of landmarks 811 (e.g., eyes, mouth, and the like) on images 801b-1, 801b-2, and 801b-3 (hereinafter, collectively referred to as “images 801b”). In addition, a portrait segmentation operation produces segmentation masks 801c-1, 801c-2, and 801c-3 (hereinafter, collectively referred to as “silhouettes 801c”). Using a neutral face PCA model with 150 dimensions built from a collection of images, the model registers 3D face meshes 847-1, 847-2, and 847-3 (hereinafter, collectively referred to as “face meshes 847”). Face meshes 847 fix their topology to observations (e.g., conditioning data 801a) by solving a non-linear optimization problem. To this end, the model optimizes PCA coefficients, a, as well as the rigid head rotation, rᵢ, and translation, tᵢ, for each frame, I, in conditioning data 801a. This includes minimizing a combination of a landmark, segmentation, depth, and coefficient regularization loss, using a Laplacian multiplier approach as:

[symbol]

_{cda}(Φ;I_{f}^{i,c})=λ_{id} [symbol] _{id}+λₛᵢₕ [symbol] ₛᵢₕ+λ_{d} [symbol] _{d}+λ_{reg} [symbol] _{reg} (9)

Here, the landmark loss, [symbol] _{ld}, is defined by the 1₁-distance between the detected 2D landmarks and the corresponding 3D landmark locations of the corresponding mesh vertices. For the segmentation silhouette loss, Lₛᵢₕ, the 1₁-distance is measured as screen space between the vertices at the silhouette of the projected mesh and their closest points on the boundary of the portrait segmentations 801c. To compute the depth loss, [symbol] _{d}, the model traces rays from each vertex in the normal and inverse normal direction and intersects them with triangle meshes generated from the depth maps. [symbol] _{d} is defined as the 1₁-distance between the mesh vertices and the intersections. The model regularizes the PCA coefficients using Tikhonov regularization as [symbol] _{reg}. In some embodiments, λ_{ld}=5.0, λₛᵢₕ=0.5, λ_{d}=1.0 and λ_{reg}=0.01, and keep them fixed for all subjects. The PCA model approximates the actual shape of the subject's face. This process produces a reconstructed face mesh that aligns with the input image well (cf. silhouettes 801c). We use this mesh to unwrap the texture from each mesh 847 and aggregate them to obtain the complete face texture for avatars 802. The textures are aggregated by weighted averaging, where the weight of each texture is a function of the viewing angle, surface normal, and visibility. The final rendered meshes in subject avatars 802 include the aggregated textures.

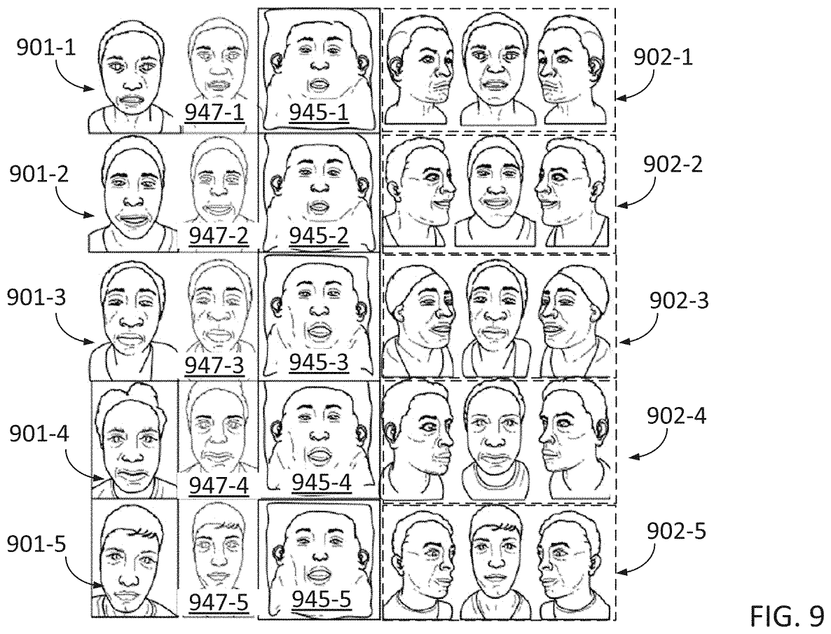

FIG. 9 illustrates personalized decoders including reconstructed meshes 947-1, 947-2, 947-3, 947-4, and 947-5 (hereinafter, collectively referred to as “reconstructed meshes 947”) and aggregated textures 945-1, 945-2, 945-3, 945-4, and 945-5 (hereinafter, collectively referred to as “aggregated textures 945”) for rendering subject avatars 902-1, 902-2, 902-3, 902-4, and 902-5 (hereinafter, collectively referred to as “subject avatars 902”) from input images 901-1, 901-2, 901-3, 901-4, and 901-5 (hereinafter, collectively referred to as “input images 901”), according to some embodiments.

The model transforms reconstructed meshes 947 to the neutral geometry image, Gₙₑᵤ, which together with textures 945 (Tₙₑᵤ) form the conditioning data fed into the UPM to create subject avatars 902. In some instances, there may be a domain gap between the data used to train the UPM and images 901, acquired with a mobile phone. First, the lighting environment used to train the UPM is static and uniformly lit, whereas natural illumination conditions in images 901 exhibit more variations. Second, the mobile phone capture only covers the frontal half hemisphere of the head due to physical limitations (hard for a user to scan the back of their heads with a mobile phone). To bridge the domain gap between a mobile phone and capturing studio data, the model applies a neutral face fitting algorithm to the captured studio data, where a handheld camera motion is substituted by a discrete selection of cameras following a similar trajectory (cf. studio 500). The UPM is then trained with neutral conditioning data generated from this process, while keeping the high quality mesh tracking 945 and 947 for supervising the guide mesh and per-frame head pose.

This process significantly improves the quality of subject avatars 902, as the UPM learns to inpaint regions that tend to be unobserved when following the mobile phone capture script. To account for the lighting and color transforms between the mobile phone and studio data, some embodiments apply texture normalization, including an exhaustive search over the dataset of 255 identities, estimating optimal per-channel gains to match each, and pick the one image with minimal error. This normalized texture, together with personalized meshes 945 and 947, are fed into an identity encoder (e.g., E_{id} 441), to generate person-specific bias maps (e.g., bias maps 448), which together with a decoder (e.g., decoder 430), generate subject avatars 902.

Given a set of images 901 with arbitrary facial expression, the model runs a 3-color+depth (RGB-D) based 3D face tracker to unwrap textures 945 from images 901, normalize it, and fill-in unobserved parts with a neutral texture. The tracked 3D face mesh and texture is used as the expression data input to an expression encoder (e.g., Eₑₓₚ 441), which along with the bias maps and decoder, D, can be used to generate volumetric primitives that can be ray-marched to produce an image. While the personalized decoder generates reasonable likeness with a hallucinated expression span, it often misses transient detail, such as wrinkles that are not apparent while the user's face is in a neutral expression. To build a more authentic avatar, the model leverages data of the 65 facial expressions captured using the mobile phone from a frontal view. This capture takes 3.5 minutes on average, and subjects rarely experience any difficulty in following the script. With these expression frames, {I_{f}}, the system performs an analysis by synthesis to fine-tune the network parameters of subject avatars by minimizing:

[symbol]

_{ref}(Φ;I_{f})= [symbol] _{rec}(Φ;I_{f})+ [symbol] ₕₒₗₑ(Φ;I_{f})+L_{seg}(Φ;I_{f}) (10)

[symbol]

ₕₒₗₑ(Φ;Iₚ)=λₕₒₗₑ∥max(T_{f}−O_{f},0)·T_{f}∥₁ (11)

where T_{f} is a rendered mask that covers the face region and O_{f} is the integrated opacity computed during ray marching. [symbol] ₕₒₗₑ(Φ; I_{f}) penalizes holes that can emerge during fine-tuning because of the MVP surface primitives separating from each other. To ensure generalization to expressions not in the captured data, we also evaluate this loss on samples from the training corpus with a proportion of 1%. In some fine-tuning embodiments, Laplacian multipliers may be set at λₚₕₒ=1, λ_{VGG}=3, λ_{GAN}=0.1, λ_{seg}=0.1, and λₕₒₗₑ=100.

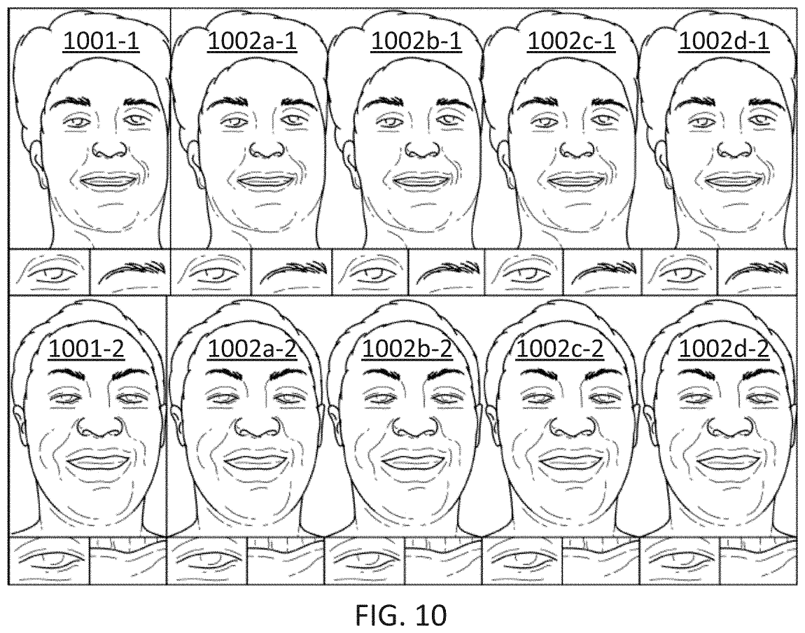

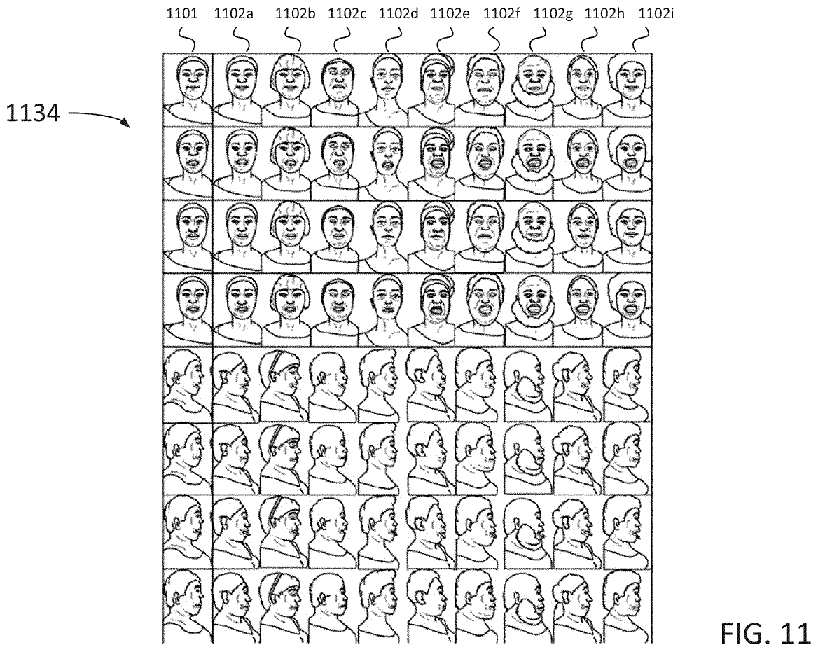

FIG. 10 illustrates a loss function effect for high fidelity avatars 1002a-1, 1002a-2 (collectively referred to as “avatars 1002a”), 1002b-1, 1002b-2 (collectively referred to as “avatars 1002b”), 1002c-1, 1002c-2 (collectively referred to as “avatars 1002b”), and 1002d-1, 1002d-2 (collectively referred to as “avatars 1002d”), from input images 1001-1 and 1001-2 (hereinafter, collectively referred to as “input images 1001”), according to some embodiments. Avatars 1002a, 1002b, 1002c, and 1002d will be collectively referred to as “avatars 1002.”

The reconstruction loss in a UPM as disclosed herein (cf. Eq. 10 and UPM 400) has a significant effect on the amount of detail that is reconstructed by the decoder. Avatars 1002a are obtained using a distance metric 12, avatars 1002b are obtained using a distance metric l₁, avatars 1002c are obtained using a distance metric l_{1+vgg}, and avatars 1002d are obtained using a distance metric l_{1+vgg+gan}. As can be seen, the loss function produces the highest fidelity avatars.

FIG. 1₁ illustrates an expression consistent latent space 1134 provided by a UPM (cf. UPM 400), according to some embodiments. The left-most column includes images 1101 of the source identity of the subjects (e.g., collected in a studio or via a mobile phone). Second-from left column includes subject avatars 1102a using UPM reconstructions. Further columns include subject avatars 1102b, 1102c, 1102d, 1102e, 1102f, 1102g, 1002h, and 1002i, with retargeting results by decoding UPM based on different identity conditioning data.

FIG. 12 illustrates an expression retargeting function 1200 and results, according to some embodiments. Expression retargeting function 1200 includes neutral-subtracted input image 1201 into an expression encoder (cf. Eₑₓₚ 442), that results in entangled expressions 1234a and 1234b to generate subject avatar 1202.

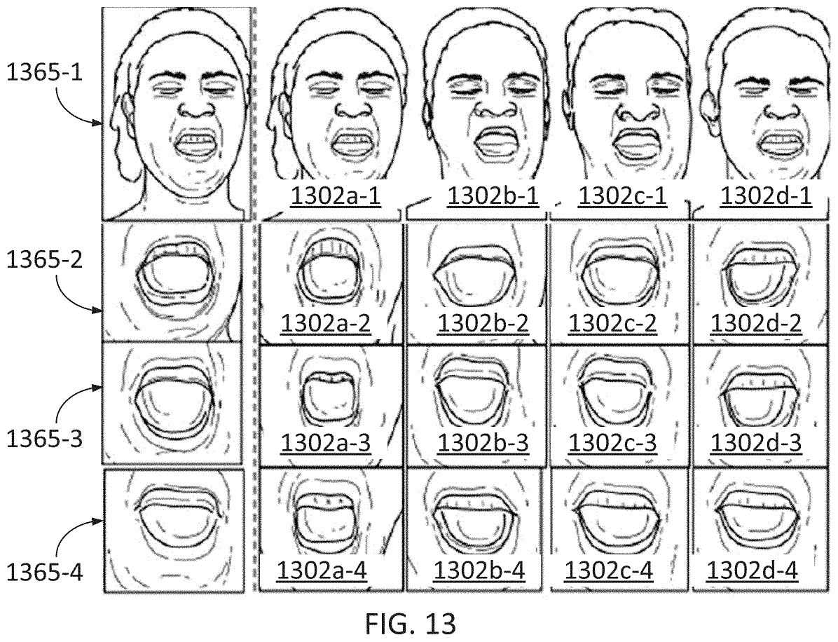

FIG. 13 illustrates identity invariant results from a latent expression space (e.g., latent expression space 234), according to some embodiments. Different expressions from different subjects, 1365-1, 1365-2, 1365-3, and 1365-4 (hereinafter, collectively referred to as “expressions 1365”) are re-targeted, or “imprinted” amongst the different subjects. For example, expression 1365-1 is re-targeted onto avatars 1302a-1, 1302b-1, 1302c-1, and 1302d-1, for different subjects. Likewise, expression 1365-2 is re-targeted onto avatars 1302a-2, 1302b-2, 1302c-2, and 1302d-2, for different subjects. Expression 1365-3 is re-targeted onto avatars 1302a-3, 1302b-3, 1302c-3, and 1302d-3, for different subjects. And expression 1365-4 is re-targeted onto avatars 1302a-4, 1302b-4, 1302c-4, and 1302d-4, for different subjects. Avatars 1302a-1, 1302a-2, 1302a-3, 1302a-4, 1302b-1, 1302b-2, 1302b-3, 1302b-4, 1302c-1, 1302c-2, 1302c-3, 1302c-4, 1302d-1, 1302d-2, 1302d-3, and 1302d-4 will be collectively referred to, hereinafter, as “avatars 1302.”

UPM as disclosed herein re-targets one training subject's expression 1365 to another subject avatar 1302 by inputting the source identity's expression 1365 into an expression encoder (e.g., Eₑₓₚ 442) and use target identity as neutral conditioning data into an identity encoder (e.g., E_{id} 441). The model retains the semantics of a latent expression space even across identities with significantly different facial shape and appearance, despite the fact that the UPM did not explicitly define expression correspondences during training (cf. the capture script in studio 500). Inputs to expression encoder (cf. texture map 445-1 and geometry map 447-1) contain identity-specific information that may not be expression specific, e.g., the shape of teeth. Surprisingly, the UPM model successfully transfers the source identity's overall expression to the target identities, while the decoded teeth remain those of each target's identity, as desirable. Thus, training the UPM model teaches the identity encoder to correlate neutral facial appearance and geometry with teeth, at least approximately. Some embodiments enrich the conditioning information set (for the expression encoder) with additional expressions. Some embodiments may rely on a fine-tuning strategy, which has more flexibility in leveraging expressions available at test time, instead of requiring the set to be predefined a-priori.

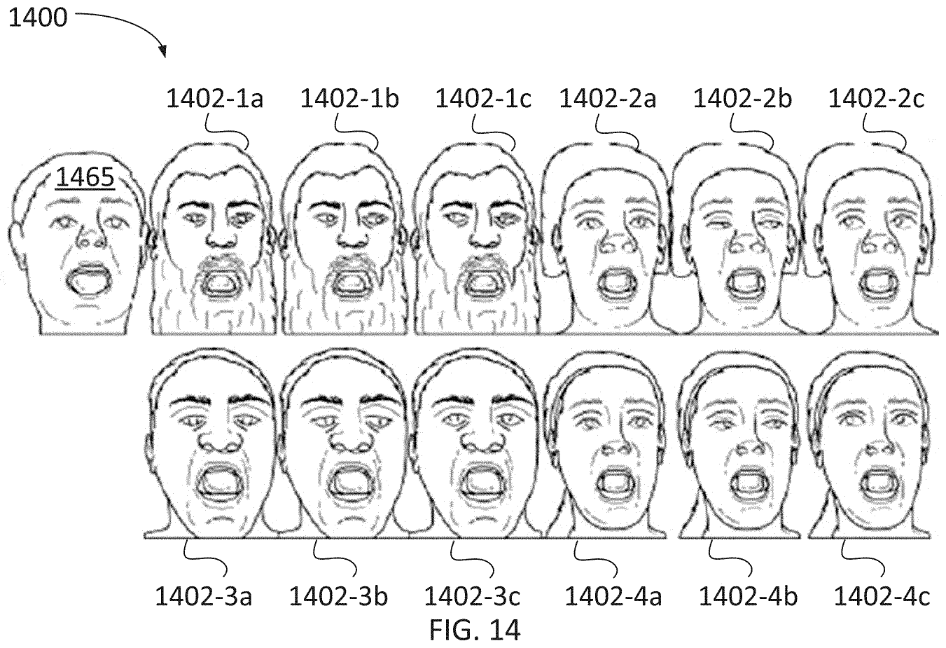

FIG. 14 illustrates explicit gaze control 1400 via a disentangled representation, according to some embodiments. An expression 1465 may be retrieved from a latent expression space (e.g., latent expression space 234), and then re-targeted to different subjects, -1, -2, -3, and -4, each associated with an avatar a, b, c, displaying different gaze direction. Accordingly, avatars 1402-1a, 1402-1b, and 1402-1c indicate subject 1 having expression 1465 and gazing in three different directions. Likewise, avatars 1402-2a, 1402-2b, and 1402-2c indicate subject 2 having expression 1465 and gazing in the same three different directions. Avatars 1402-3a, 1402-3b, and 1402-3c indicate subject 3 having expression 1465 and gazing in the same three different directions. And avatars 1402-4a, 1402-4b, and 1402-4c indicate subject 2 having expression 1465 and gazing in the same three different directions.

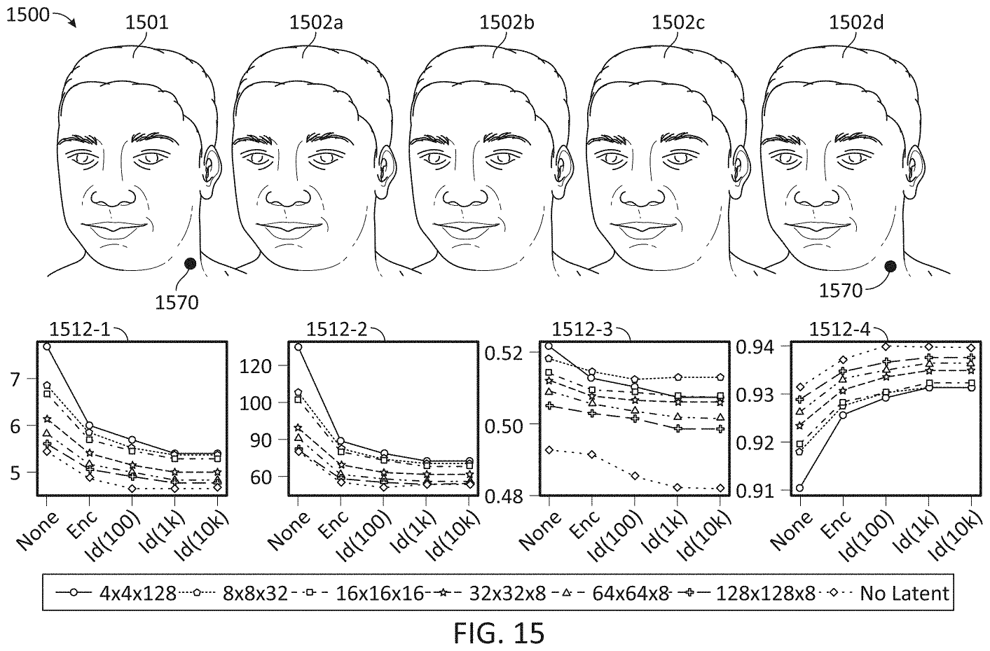

FIG. 15 illustrates a fine-tunning operation 1500 (over 1000 iterations) on avatars 1502a (resolution 4×4×128), 1502b (resolution 32×32×8), 1502c (resolution 128×128×8), and 1502d (no identity latent space, hereinafter, collectively referred to as “avatars 1502”) from an input image 1501, using an identity latent space of different spatial resolutions, and no identity latent space, according to some embodiments. Charts 1512-1, 1512-2, 1512-3, and 1512-4 (hereinafter, collectively referred to as “charts 1512”) indicate average reconstruction errors on range-of-motion sequences of 22 unseen subjects, using four different metrics (1₁, MSE, VGG, and SSIM, respectively). Charts 1512 include an abscissa wherein “none” refers to results without fine-tuning, “enc” fine tunes expression encoding, and “id{x)” fine tunes the identity encoding for x iterations.

As illustrated in charts 1512 as the identity latent space increases in spatial resolution, so does reconstruction performance. Increasing the spatial resolution of the identity latent space enables more flexibility to model unseen variations due to each latent code's localized spatial footprint on the output. An identity latent space produces avatars with a similar, but recognizably different, identity.

VGG scores (chart 1512-3) trend higher on these results because VGG scores are sensitive to the similarity in details between avatars 1502 and the source image. Without an identity latent space, UPM captures fine details like a mole 1570 on the neck, and achieves smaller VGG scores. Using an identity latent space, a UMP as disclosed herein may support identity interpolation and relies on conditioning data to a specific individual to generate an avatar.

TABLE 1
Ablation study on data used for finetuning.

| Neutral | Expr. | l₁ (↓) | MSE (↓) | SSIM (↑) | LPIPS (↓) | VGG (↓) |
|---|---|---|---|---|---|---|
| None | None | 14.55 | 137.79 | 0.9398 | 0.1226 | 0.2309 |
| Frontal | None | 15.40 | 173.31 | 0.9208 | 0.1290 | 0.2526 |
| All | None | 13.47 | 142.72 | 0.9359 | 0.1104 | 0.2340 |
| Frontal | All | 9.55 | 78.21 | 0.9435 | 0.1011 | 0.2304 |
| All | 2 | 12.26 | 124.44 | 0.9361 | 0.1100 | 0.2369 |
| All | 4 | 11.46 | 111.61 | 0.9395 | 0.1061 | 0.2329 |
| All | 8 | 10.56 | 96.86 | 0.9435 | 0.1019 | 0.2284 |
| All | 16 | 10.01 | 88.42 | 0.9459 | 0.0991 | 0.2254 |
| All | 32 | 9.72 | 82.82 | 0.9467 | 0.0983 | 0.2249 |
| All | All | 9.18 | 74.33 | 0.9477 | 0.0966 | 0.2238 |

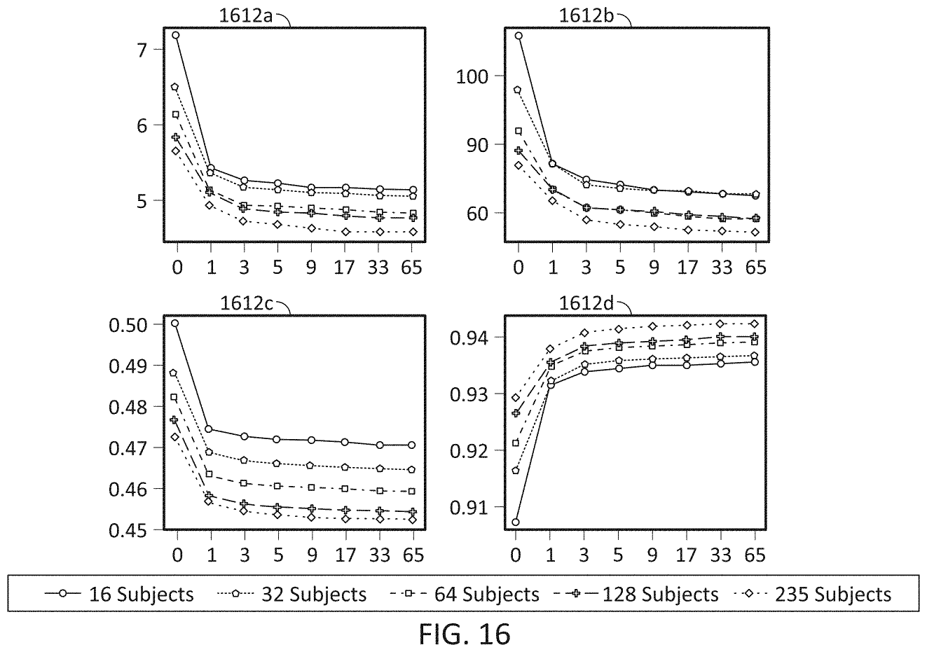

FIG. 16 illustrates performance charts 1612a, 1612b, 1612c, and 1612d (hereinafter, collectively referred to as “charts 1612”) for UPM with different metrics (1₁, MSE, VGG, and SSIM, respectively), and for a different number of subjects (16, 32, 64, 128, and 235), according to some embodiments. On the remaining subjects, the UPM is fine-tuned with increasing amounts of expression data 1, 3, 5, 9, 17, 33, and 65 expression frames (cf. abscissae in charts 1612), with five cameras each (cf. cameras 525 in studio 500). After fine-tuning for 1000 iterations, the models were evaluated on a held-out range-of-motion sequence. Increasing the amount of training identities improves results, as expected. Similarly, additional fine-tuning data also leads to better results. A trade-off between what can be acquired as part of the training set versus what can be acquired at the user's end is application specific. Improved performance may continue beyond a corpus size of 235, even when employing 65 fine-tuning expressions.

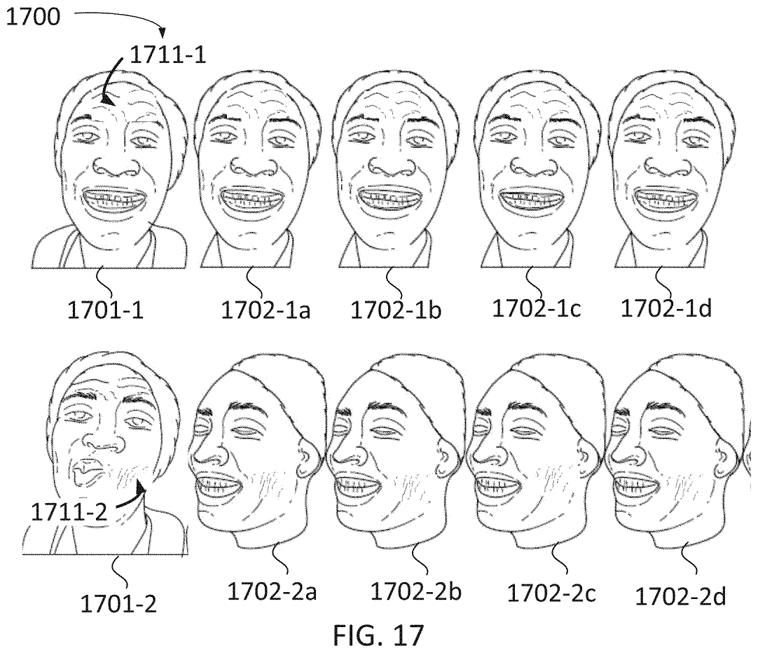

FIG. 17 illustrates ablation procedures 1700 on losses used in fine-tuning, according to some embodiments. Procedures 1700 show reconstruction results for mobile phone personalized avatars 1702-1a, 1702-1b, 1702-1c, and 1702-1d (hereinafter, collectively referred to as “avatars 1702-1”), fine-tuned with different losses to an input image 1701-1, having a first landmark 1711-1 (with -a, -b, -c, and -d indicative of 1₁, +VGG, +Hole, and +GAN losses, respectively). Avatars 1702-2a, 1702-2b, 1702-2c, and 1702-2d (hereinafter, collectively referred to as “avatars 1702-2”) result from input image 1701-2 having a second landmark 1711-2. Landmarks 1711-1 and 1711-2 may be wrinkles in the forehead and cheek, respectively (hereinafter, collectively referred to as “landmarks 1711”). A UPM model employing only an 1₁ norm as the photometric loss (cf. Eqs. 6-7) results in blurry reconstruction. Incorporating the VGG loss helps to enhance sharpness of the resulting image (cf. 1702-1b and 1702-2b). However, to reduce hole-like artifacts, resulting from rays missing the surface during ray matching, a fine-tuned UPM model includes hole-loss (cf. Eq. 11) that significantly reduces such artifacts (cf. 1702-1c and 1702-2c). Finally, adding the GAN-loss improves quality of the result (cf. 1702-1d and 1702-2d). Avatars 1702-1 and 1702-2 will be referred to, hereinafter, as “avatars 1702.”

Performance characteristics of avatars 1702 are summarized in Table 1. Fine-tuning avatars 1702 reconstruct subject's expression correctly, reducing reconstruction errors. Fine-tuning on neutral frontal images alone may result in overfitting, where performance degrades on a held-out set of images (e.g., images not used for training the UPM). Using all frames of the neutral multi-view scan helps reduce overfitting. Fine-tuning on the full expression set without the multi-view-neutral frames can effectively reduce reconstruction error (cf. Table 1 Frontal/All). Finally, when fine-tuning using the complete set of expression and multi-view data, the personalized avatar produces accurate expression reconstructions without any artifacts when rendered in non-frontal views (cf. avatars 1702-1d and 1702-2d). Table 1 shows a trend of improving performance as the fine-tuning set of expressions increases.

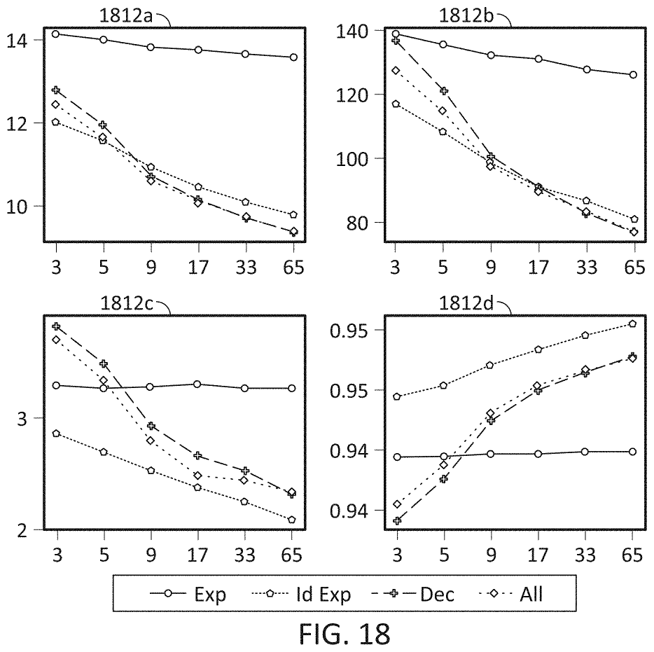

FIG. 18 illustrates charts 1812a, 1812b, 1812c, and 1812d (hereinafter, collectively referred to as “charts 1812”) illustrating the effect of fine-tuning a dataset size on performance on different parts of the model (-a, -b, -c, and -d corresponding to 1₁, MSE, VGG, and SSIM, losses respectively), according to some embodiments. The abscissae in charts 1812 indicates the number of subjects used for training the UPM. The different curves correspond to “expression,” “identity and expression,” “decoder,” and “all” fine-tuning parameters. The data is shown in Table 2. Fine-tuning all parts gives the lowest 1₁-error, mean square error (MSE), and IPIPS metric. Fine-tuning the encoder (-b, identity and expression) achieves the best SSIM score and lowest VGG score.

TABLE 2
Ablation study on finet uning different parts of the model

| Components | l₁ (↓) | MSE (↓) | SSIM (↑) | LPIPS (↓) | VGG (↓) |
|---|---|---|---|---|---|
| εₑₓₚ | 13.48 | 123.84 | 0.9401 | 0.1231 | 0.2329 |
| ε_{id} | 10.33 | 88.98 | 0.9485 | 0.1125 | 0.2236 |
| ε_{id} + εₑₓₚ | 9.70 | 82.65 | 0.9504 | 0.1081 | 0.2221 |
| D | 9.29 | 76.57 | 0.9471 | 0.0974 | 0.2244 |
| ε_{id} + D | 9.27 | 76.59 | 0.9472 | 0.0975 | 0.2254 |
| Full method | 9.18 | 74.33 | 0.9477 | 0.0966 | 0.2238 |

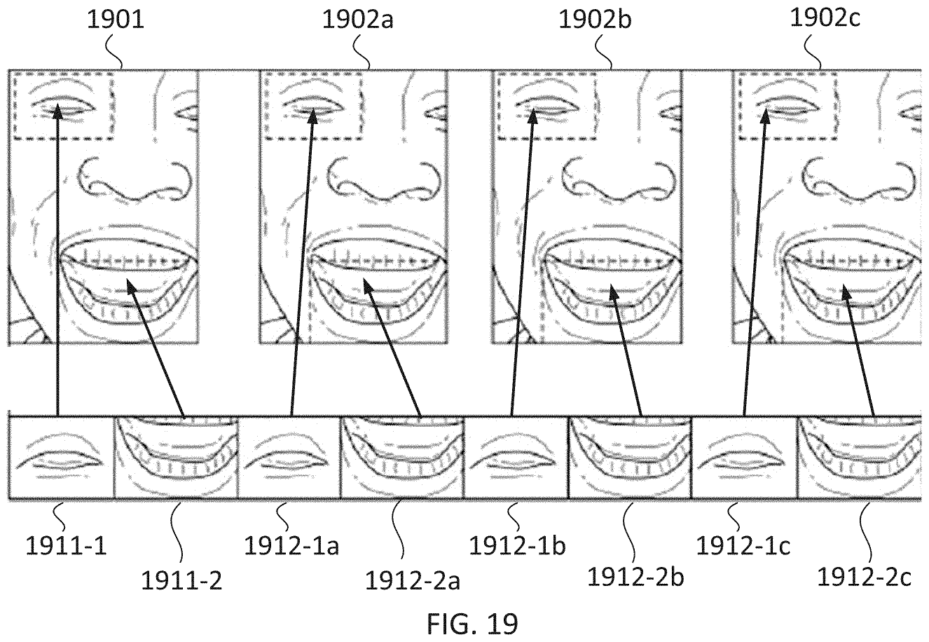

FIG. 19 illustrates the effect of a learning rate on fine-tuning, according to some embodiments. An input image 1901 has landmarks 1911-1 (eye) and 1911-2 (mouth), hereinafter, collectively referred to as “landmarks 1911.” Avatars 1902a, 1902b, and 1902c (hereinafter, collectively referred to as “avatars 1902”) include features 1912-1a, 1912-1b, and 1912-1c (hereinafter, collectively referred to as “features 1912-1”), respectively, for landmark 1911-1. And avatars 1902 also include features 1912-2a, 1912-2b, and 1912-2c (hereinafter, collectively referred to as “features 1912-2”). For avatars 1902, reference -a, -b, and -c indicate learning rates 104, 10-3, and 102, respectively.

UPMs as disclosed herein are trained on multi-view data of 235 identities. To keep the expression space consistent and preserve view-dependent properties, it is desirable to select the learning rate during fine-tuning. Accordingly, learning rate 10⁻⁴, may be too small and the UPM fails to recover sufficient facial detail such as landmark 1911-1. When the learning rate is too large 10⁻², the UPM may have overfits and performance degrades on held-out data. In some embodiments, a learning rate 10⁻³ produces detailed reconstructions while also generalizing new expressions (e.g., no overfitting).

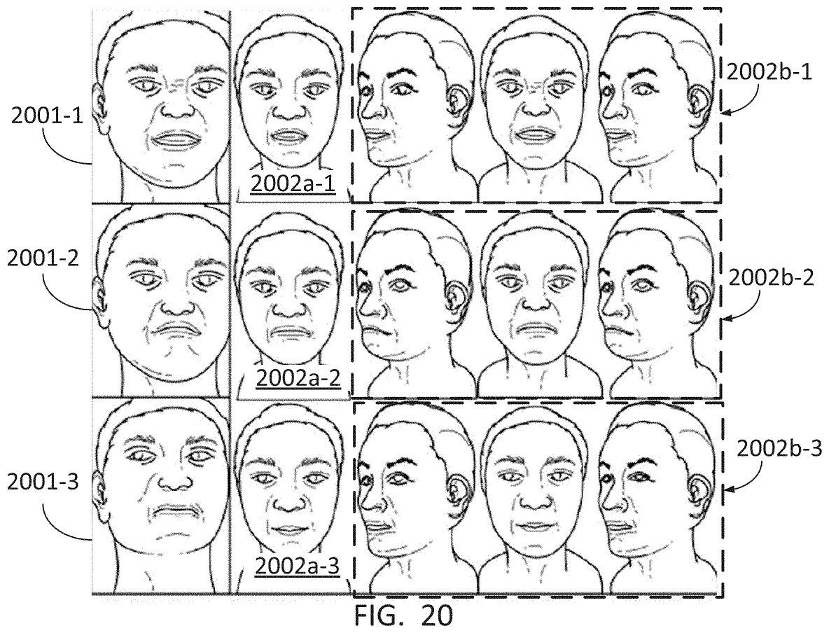

FIG. 20 illustrates a comparison of avatars 2002a-1, 2002a-2, and 2002a-3 (hereinafter, collectively referred to as “avatars 2002a”), and 2002b-1, 2002b-2, and 2002b-3 (hereinafter, collectively referred to as “avatars 2002b”) created from a multi-view studio modeling (avatars 2002a) and from a mobile phone scan (avatars 2002b) from input images 2001-1, 2001-2, and 2001-3 (hereinafter, collectively referred to as “input images 2001”), according to some embodiments. The quality of avatars 2002a and 2002b is indistinguishable to the naked eye.

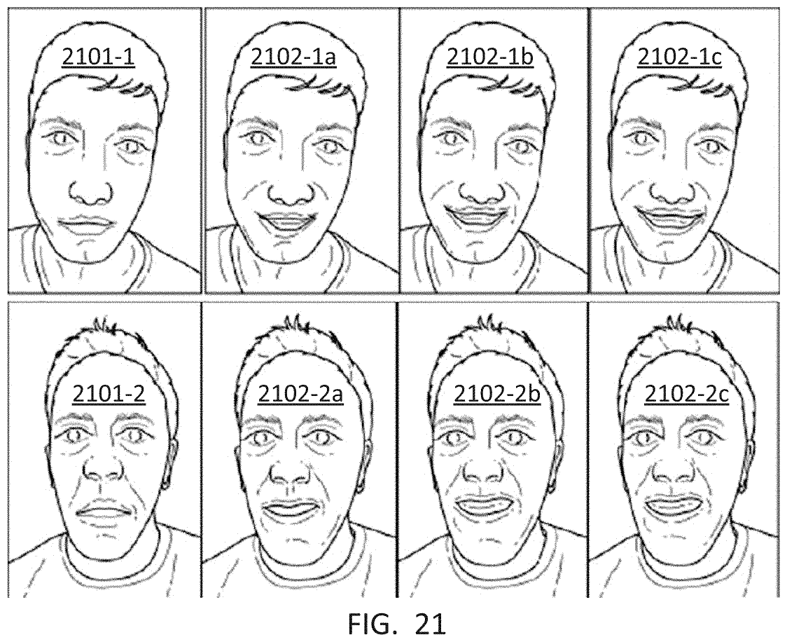

FIG. 21 illustrates a comparison of avatars 2102-1a, 2102-1b, and 2102-1c (hereinafter, collectively referred to as “avatars 2102-1”), and 2102-2a, 2102-2b, and 2102-2c (hereinafter, collectively referred to as “avatars 2102-2”) created from a multi-view studio modeling (avatars 2102-1a and 2102-2a) and from a mobile phone scan (avatars 2102-1b and 2102-2b, no fine-tuning, and avatars 2102-1c and 2102-2-c, with fine-tuning) from input images 2101-1 and 2101-2 (hereinafter, collectively referred to as “input images 2101”), according to some embodiments.

Avatars 2102-1a and 2102-2a are created from input images 2101 into a GAN-based framework. While studio avatars 2102-1a and 2102-2a are high quality, mobile phone avatars 2102-1b, 2102-2b, 2102-1c, and 2102-2c produce an authentic representation with high realism. Studio avatars 2102-1a and 2102-2a modify input images 2101 to show synthesized smiles. As a comparison, mobile phone avatars 2102-1b, 2102-1c, and 2101-2b, 2102-2c show similar results that better preserve the user's likeness with semantically more consistent expressions.

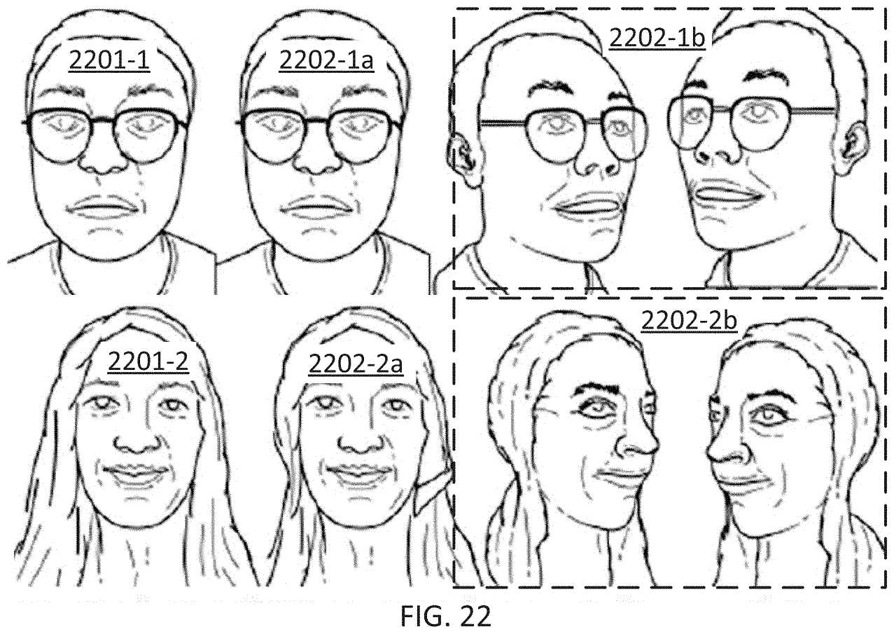

FIG. 22 illustrates avatars 2202-1a, 2202-1b (hereinafter, collectively referred to as “avatars 2202-1”), 2202-2a, 2202-2b (hereinafter, collectively referred to as “avatars 2202-2”), created from a mobile phone scan including glasses (avatars 2201-1) and long hair avatars 2201-2, according to some embodiments.

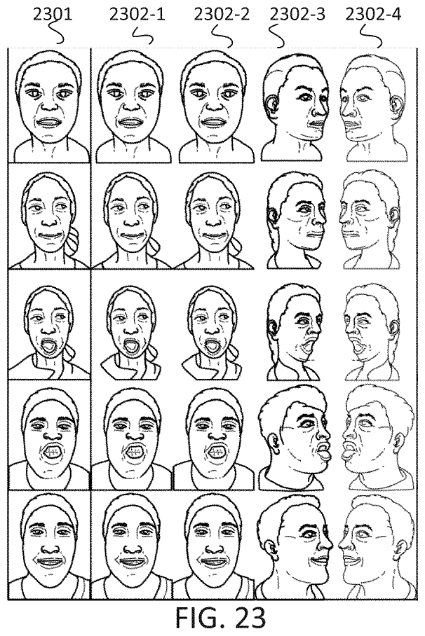

FIG. 23 illustrates refined personalized avatars 2302-1, 2302-2 (avatar depth), 2302-3 (¾ left view), and 2302-4 (¾ right view, hereinafter, collectively referred to as “avatars 2302”) collected from an input mage 2301, according to some embodiments. Avatars 2302 include fine-tuning frontal view expression images, the view-dependent property of face expression well preserved, which allows us to render the avatar from different viewpoints.

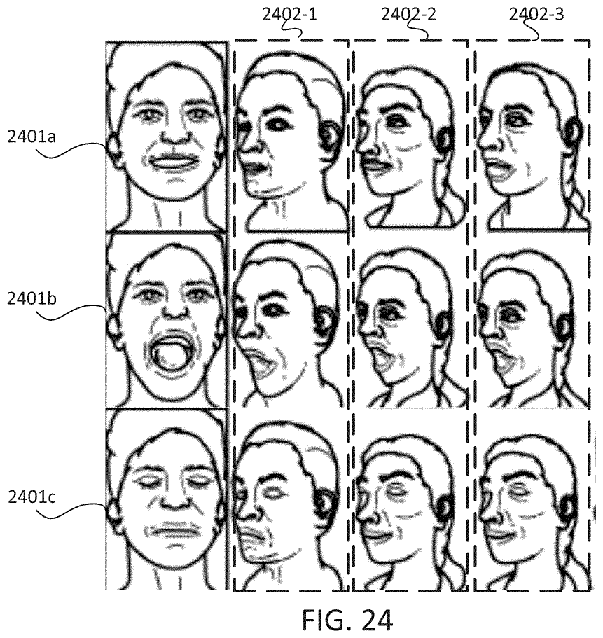

FIG. 24 illustrates personalized avatars 2402-1, 2402-2, and 2402-3 (hereinafter, collectively referred to as “avatars 2402”) imprinted on different subjects from images 2401a, 2401b, and 2401c (hereinafter, collectively referred to as “images 2401”), corresponding to different expressions of a first model subject, according to some embodiments.

Avatars 2402 show some retargeting examples from a single identity in the dataset (1st column). The UPM passes the tracked mesh and texture into the expression encoder, to obtain the expression code, and feeds it into the decoder of each one of avatars 2402. The expression of the source identity 2401 is transferred to the different avatars 2402 seamlessly, while details such as teeth and wrinkles are preserved. Avatars 2402-2 and 2402-3 show the same subject captured at different times in different environments. The recovered avatar's identity is consistent between the two captures.

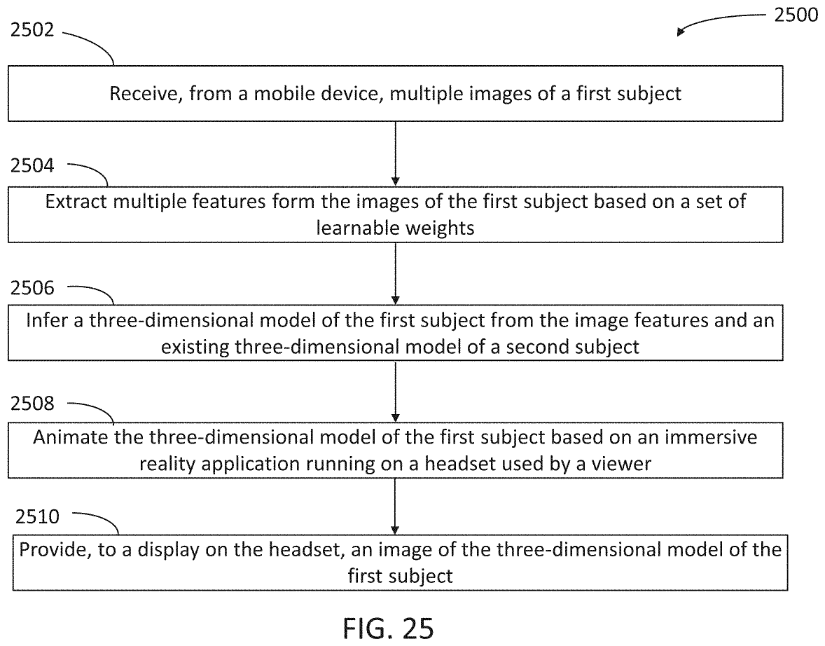

FIG. 25 is a flow chart illustrating steps in a method 2500 for providing a video scan to a remote server to create a subject avatar, according to some embodiments. Steps in method 2500 may be performed at least partially by a processor executing instructions stored in a memory, wherein the processor and the memory are part of a client device or a VR/AR headset as disclosed herein (e.g., memories 220, processors 212, and client devices 110). In yet other embodiments, at least one or more of the steps in a method consistent with method 2500 may be performed by a processor executing instructions stored in a memory wherein at least one of the processor and the memory are remotely located in a cloud server and a database, and the headset device is communicatively coupled to the cloud server via a communications module coupled to a network (cf. server 130, databases 152 and 252, communications modules 218, and network 150). In some embodiments, the server may include a volumetric avatar engine having an avatar model with an encoder-decoder tool, a ray marching tool, and a radiance field tool, and the server memory may store a latent expression space, as disclosed herein (e.g., volumetric avatar engine 232, latent expression space 234, avatar model 240, encoder-decoder tool 242, ray marching tool 244, radiance field tool 246, and bias mapping tool 248). In some embodiments, methods consistent with the present disclosure may include at least one or more steps from method 2500 performed in a different order, simultaneously, quasi-simultaneously, or overlapping in time.

Step 2502 includes receiving, from a mobile device, multiple images of a first subject. In some embodiments, step 2502 includes receiving at least a neutral expression image of the first subject. In some embodiments, step 2502 includes receiving at least an expressive image of the first subject. In some embodiments, step 2502 includes receiving a sequence of images collected by scanning the mobile device in a selected direction over the first subject.

Step 2504 includes extracting multiple image features from the images of the first subject based on a set of learnable weights.

Step 2506 includes inferring a three-dimensional model of the first subject from the image features and an existing three-dimensional model of a second subject. In some embodiments, step 2506 includes biasing the three-dimensional model of the first subject along a direction selected for collecting the images of the second subject. In some embodiments, step 2506 includes masking a gaze direction in the three-dimensional model of the first subject and inserting a gaze direction of the second subject. In some embodiments, the image features include an identity feature of the first subject, and step 2506 includes replacing an identity feature of the first subject with the identity feature of the second subject. In some embodiments, the image features include an expression feature of the first subject, and step 2506 includes matching the expression feature of the first subject in a latent expression database.

Step 2508 includes animating the three-dimensional model of the first subject based on an immersive reality application running on a headset used by a viewer. In some embodiments, step 2508 includes projecting the image features along a direction between the three-dimensional model of the first subject and a selected observation point for the viewer. In some embodiments, step 2508 includes adding an illumination source for the three-dimensional model of the first subject based on the three-dimensional model of the second subject stored in the database.

Step 2510 includes providing, to a display on the headset, an image of the three-dimensional model of the first subject.

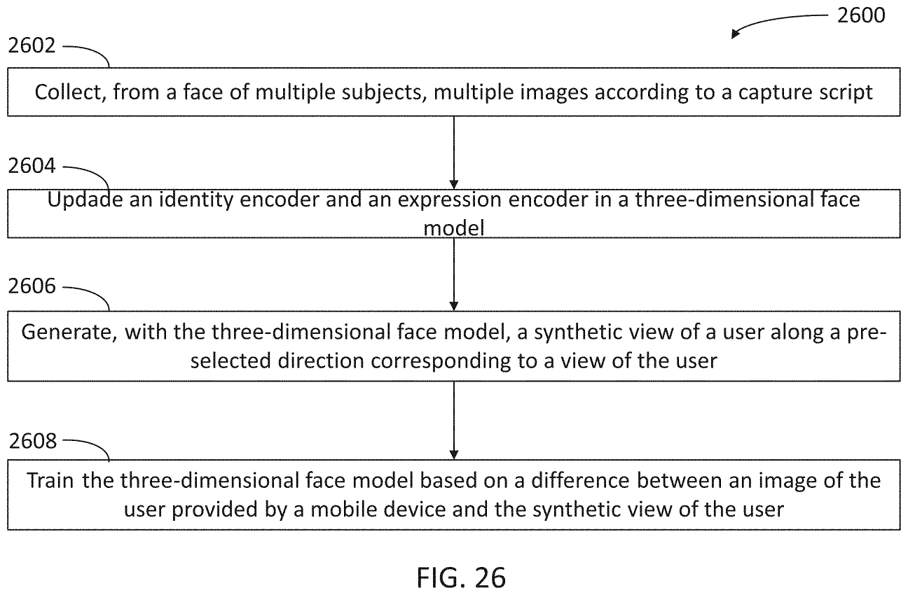

FIG. 26 is a flow chart illustrating steps in a method 2600 for generating a subject avatar from a video scan provided by the subject, according to some embodiments. Steps in method 2600 may be performed at least partially by a processor executing instructions stored in a memory, wherein the processor and the memory are part of a client device or a VR/AR headset as disclosed herein (e.g., memories 220, processors 212, and client devices 110). In yet other embodiments, at least one or more of the steps in a method consistent with method 2600 may be performed by a processor executing instructions stored in a memory wherein at least one of the processor and the memory are remotely located in a cloud server and a database, and the headset device is communicatively coupled to the cloud server via a communications module coupled to a network (cf. server 130, databases 152 and 252, communications modules 218, and network 150). In some embodiments, the server may include a volumetric avatar engine having an avatar model with an encoder-decoder tool, a ray marching tool, and a radiance field tool, and the server memory may store a latent expression space, as disclosed herein (e.g., volumetric avatar engine 232, latent expression space 234, avatar model 240, encoder-decoder tool 242, ray marching tool 244, radiance field tool 246, and bias mapping tool 248). In some embodiments, methods consistent with the present disclosure may include at least one or more steps from method 2600 performed in a different order, simultaneously, quasi-simultaneously, or overlapping in time.

Step 2602 includes collecting, from a face of multiple subjects, multiple images according to a capture script. In some embodiments, step 2602 includes collecting each of the images with a pre-selected illumination configuration. In some embodiments, step 2602 includes collecting images with different expressions for each subject.

Step 2604 includes updating an identity encoder and an expression encoder in a three-dimensional face model.

Step 2606 includes generating, with the three-dimensional face model, a synthetic view of a user along a pre-selected direction corresponding to a view of the user.

Step 2608 includes training the three-dimensional face model based on a difference between an image of the user provided by a mobile device, and the synthetic view of the user. In some embodiments, step 2608 includes using a metric for a geometric artifact of the three-dimensional face model based on an image of the user. In some embodiments, step 2608 includes using a metric for an identity artifact of the three-dimensional face model.

### Hardware Overview

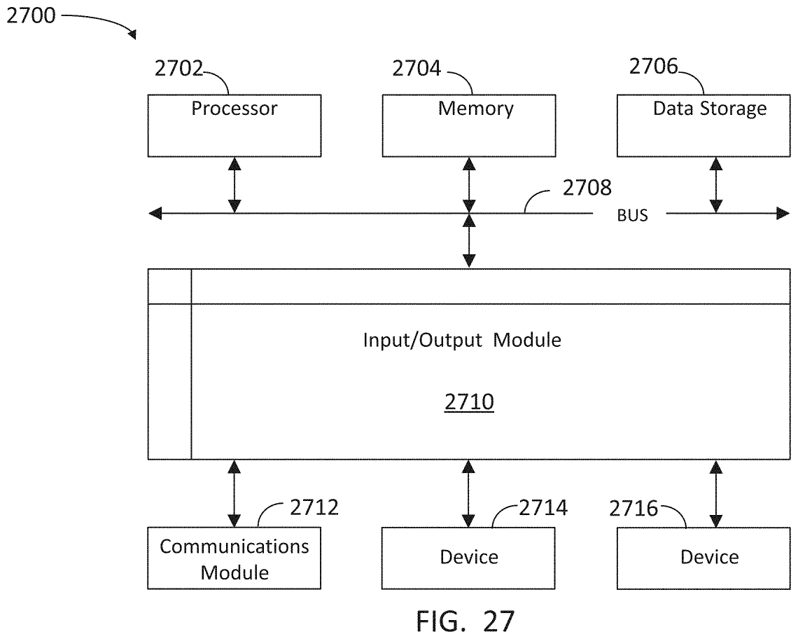

FIG. 27 is a block diagram illustrating an exemplary computer system 2700 with which headsets and other client devices 110, and methods 2500 and 2600 can be implemented. In certain aspects, computer system 2700 may be implemented using hardware or a combination of software and hardware, either in a dedicated server, or integrated into another entity, or distributed across multiple entities. Computer system 2700 may include a desktop computer, a laptop computer, a tablet, a phablet, a smartphone, a feature phone, a server computer, or otherwise. A server computer may be located remotely in a data center or be stored locally.

Computer system 2700 includes a bus 2708 or other communication mechanism for communicating information, and a processor 2702 (e.g., processors 212) coupled with bus 2708 for processing information. By way of example, the computer system 2700 may be implemented with one or more processors 2702. Processor 2702 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 2700 can include, in addition to hardware, code that creates an execution environment for the computer program in question, e.g., code that constitutes processor firmware, a protocol stack, a database management system, an operating system, or a combination of one or more of them stored in an included memory 2704 (e.g., memories 220), such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled with bus 2708 for storing information and instructions to be executed by processor 2702. The processor 2702 and the memory 2704 can be supplemented by, or incorporated in, special purpose logic circuitry.

The instructions may be stored in the memory 2704 and implemented in one or more computer program products, e.g., one or more modules of computer program instructions encoded on a computer-readable medium for execution by, or to control the operation of, the computer system 2700, and according to any method well known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 2704 may also be used for storing temporary variable or other intermediate information during execution of instructions to be executed by processor 2702.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 2700 further includes a data storage device 2706 such as a magnetic disk or optical disk, coupled with bus 2708 for storing information and instructions. Computer system 2700 may be coupled via input/output module 2710 to various devices. Input/output module 2710 can be any input/output module. Exemplary input/output modules 2710 include data ports such as USB ports. The input/output module 2710 is configured to connect to a communications module 2712. Exemplary communications modules 2712 include networking interface cards, such as Ethernet cards and modems. In certain aspects, input/output module 2710 is configured to connect to a plurality of devices, such as an input device 2714 and/or an output device 2716. Exemplary input devices 2714 include a keyboard and a pointing device, e.g., a mouse or a trackball, by which a consumer can provide input to the computer system 2700. Other kinds of input devices 2714 can be used to provide for interaction with a consumer as well, such as a tactile input device, visual input device, audio input device, or brain-computer interface device. For example, feedback provided to the consumer can be any form of sensory feedback, e.g., visual feedback, auditory feedback, or tactile feedback; and input from the consumer can be received in any form, including acoustic, speech, tactile, or brain wave input. Exemplary output devices 2716 include display devices, such as an LCD (liquid crystal display) monitor, for displaying information to the consumer.

According to one aspect of the present disclosure, headsets and client devices 110 can be implemented, at least partially, using a computer system 2700 in response to processor 2702 executing one or more sequences of one or more instructions contained in memory 2704. Such instructions may be read into memory 2704 from another machine-readable medium, such as data storage device 2706. Execution of the sequences of instructions contained in main memory 2704 causes processor 2702 to perform the process steps described herein. One or more processors in a multi-processing arrangement may also be employed to execute the sequences of instructions contained in memory 2704. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., a data server, or that includes a middleware component, e.g., an application server, or that includes a front end component, e.g., a client computer having a graphical consumer interface or a Web browser through which a consumer can interact with an implementation of the subject matter described in this specification, or any combination of one or more such back end, middleware, or front end components. The components of the system can be interconnected by any form or medium of digital data communication, e.g., a communication network. The communication network can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computer system 2700 can include clients and servers. A client and server are generally remote from each other and typically interact through a communication network. The relationship of client and server arises by virtue of computer programs running on the respective computers and having a client-server relationship to each other. Computer system 2700 can be, for example, and without limitation, a desktop computer, laptop computer, or tablet computer. Computer system 2700 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to processor 2702 for execution. Such a medium may take many forms, including, but not limited to, non-volatile media, volatile media, and transmission media. Non-volatile media include, for example, optical or magnetic disks, such as data storage device 2706. Volatile media include dynamic memory, such as memory 2704. Transmission media include coaxial cables, copper wire, and fiber optics, including the wires forming bus 2708. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter affecting a machine-readable propagated signal, or a combination of one or more of them.

To illustrate the interchangeability of hardware and software, items such as the various illustrative blocks, modules, components, methods, operations, instructions, and algorithms have been described generally in terms of their functionality. Whether such functionality is implemented as hardware, software, or a combination of hardware and software depends upon the particular application and design constraints imposed on the overall system. Skilled artisans may implement the described functionality in varying ways for each particular application.

As used herein, the phrase “at least one of” preceding a series of items, with the terms “and” or “or” to separate any of the items, modifies the list as a whole, rather than each member of the list (e.g., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The word “exemplary” is used herein to mean “serving as an example, instance, or illustration.” Any embodiment described herein as “exemplary” is not necessarily to be construed as preferred or advantageous over other embodiments. Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, and other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A reference to an element in the singular is not intended to mean “one and only one” unless specifically stated, but rather “one or more.” The term “some” refers to one or more. Underlined and/or italicized headings and subheadings are used for convenience only, do not limit the subject technology, and are not referred to in connection with the interpretation of the description of the subject technology. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public, regardless of whether such disclosure is explicitly recited in the above description. No claim element is to be construed under the provisions of 35 U.S.C. § 112, sixth paragraph, unless the element is expressly recited using the phrase “means for” or, in the case of a method claim, the element is recited using the phrase “step for.”

While this specification contains many specifics, these should not be construed as limitations on the scope of what may be described, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially described as such, one or more features from a described combination can in some cases be excised from the combination, and the described combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the described subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately described subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A computer-implemented method, comprising:
receiving, from a mobile device, multiple images of a first subject;
extracting multiple image features from the images of the first subject based on a set of learnable weights;
inferring a three-dimensional model of the first subject from the image features and an existing three-dimensional model of a second subject;
animating the three-dimensional model of the first subject based on an immersive reality application running on a headset used by a viewer; and
providing, to a display on the headset, an image of the three-dimensional model of the first subject.

2. The computer-implemented method of claim 1, wherein receiving multiple images of the first subject comprises receiving at least a neutral expression image of the first subject.

3. The computer-implemented method of claim 1, wherein receiving multiple images of the first subject comprises receiving at least an expressive image of the first subject.

4. The computer-implemented method of claim 1, wherein receiving multiple images of the first subject comprises receiving a sequence of images collected by scanning the mobile device in a selected direction over the first subject.

5. The computer-implemented method of claim 1, wherein inferring a three-dimensional model of the first subject comprises biasing the three-dimensional model of the first subject along a direction selected for collecting the images of the second subject.

6. The computer-implemented method of claim 1, wherein to form a three-dimensional model of the first subject comprises masking a gaze direction in the three-dimensional model of the second subject and inserting a gaze direction of the first subject.

7. The computer-implemented method of claim 1, wherein the image features comprise an identity feature of the first subject, and to form the three-dimensional model of the first subject comprises replacing an identity feature of the second subject with the identity feature of the second subject.

8. The computer-implemented method of claim 1, wherein the image features comprise an expression feature of the first subject, and to form the three-dimensional model of the first subject comprises matching the expression feature of the first subject in a latent expression database.

9. The computer-implemented method of claim 1, wherein animating the three-dimensional model of the first subject comprises projecting the image features along a direction between the three-dimensional model of the first subject and a selected observation point for the viewer.

10. The computer-implemented method of claim 1, wherein animating the three-dimensional model of the first subject comprises including an illumination source for the three-dimensional model of the first subject based on the existing three-dimensional model of the second subject.

11. A system, comprising:
a memory storing multiple instructions; and
one or more processors configured to execute the instructions to cause the system to perform operations, comprising:
receive, from a mobile device, multiple images of a first subject;
extract multiple image features from the images of the first subject based on a set of learnable weights;
infer a three-dimensional model of the first subject from the image features and an existing three-dimensional model of a second subject;
animate the three-dimensional model of the first subject based on an immersive application running on a headset used by a viewer; and
provide, to a display on the headset, an image of the three-dimensional model of the first subject.

12. The system of claim 11, wherein to receive multiple images of the first subject the one or more processors are configured to receive at least a neutral expression image of the first subject.

13. The system of claim 11, wherein to receive multiple images of the first subject the one or more processors are configured to receive at least an expressive image of the first subject.

14. The system of claim 11, to receive multiple images of the first subject the one or more processors are configured to receive a sequence of images collected by scanning the mobile device in a selected direction over the first subject.

15. The system of claim 11, wherein to infer the three-dimensional model of the first subject the one or more processors are configured to bias the three-dimensional model of the first subject along a direction selected for collecting the images of the second subject.

16. A computer-implemented method for training a model to provide a view of a subject to an auto stereoscopic display in a virtual reality headset, comprising:
collecting, from a face of multiple subjects, multiple images according to a capture script;
updating an identity encoder and an expression encoder in a three-dimensional face model;
generating, with the three-dimensional face model, a synthetic view of a user along a pre-selected direction corresponding to a view of the user; and
training the three-dimensional face model based on a difference between an image of the user provided by a mobile device, and the synthetic view of the user.

17. The computer-implemented method of claim 16, wherein collecting multiple images according to a capture script comprises collecting each of the images with a pre-selected illumination configuration.

18. The computer-implemented method of claim 16, wherein collecting multiple images according to a capture script comprises collecting images with different expressions for each subject.

19. The computer-implemented method of claim 16, wherein training the three-dimensional face model comprises using a metric for a geometric artifact of the three-dimensional face model based on an image of the user.

20. The computer-implemented method of claim 16, wherein training the three-dimensional face model comprises using a metric for an identity artifact of the three-dimensional face model.
